(19) United States
(12) Patent Application Publication
(10) Pub. No.: US 2026/0172159 A1
(43) Pub. Date: Jun. 18, 2026

(54) COMMUNICATION METHOD AND COMMUNICATION APPARATUS

(71) Applicant: Huawei Technologies Co., Ltd., Shenzhen (CN)

(72) Inventors: Wuxian Shi, Ottawa (CA); Yiqun Ge, Ottawa (CA); Jianglei Ma, Ottawa (CA); Xiaoyan Bi, Shanghai (CN)

(21) Appl. No.: 19/411,229

(22) Filed: Dec. 6, 2025

Related U.S. Application Data
(63) Continuation of application No. PCT/CN2023/111262, filed on Aug. 4, 2023.
(60) Provisional application No. 63/507,115, filed on Jun. 9, 2023.

(51) Int. Cl. H04L 5/00; H04L 25/02; H04W 72/23

(52) U.S. Cl. CPC H04L 5/0023; H04L 5/0007; H04L 5/0048; H04L 25/0226; H04W 72/23

(57) ABSTRACT

Embodiments of the present application provide a communication method and a communication apparatus. The method includes: transmitting first information indicating information of a common pilot signal, where the common pilot signal is being transmitted on a first resource unit, and pilot signal collision of different communication devices happens at least on the first resource unit; and transmitting the common pilot signal on the first resource unit.

### CROSS-REFERENCE TO RELATED APPLICATIONS

This application is a continuation of International Application No. PCT/CN2023/111262, filed on Aug. 4, 2023, which claims priority to U.S. provisional Patent Application No. 63/507,115, filed on Jun. 9, 2023. All of the aforementioned patent applications are hereby incorporated by reference in their entireties.

### TECHNICAL FIELD

Embodiments of the present application relate to the field of communications, and more specifically, to a communication method and a communication apparatus.

### BACKGROUND

In a wireless communication system, it is important to acquire the characteristics of a channel. In order to estimate a channel, pilot signals known to both transmitting apparatus and receiving apparatus are transmitted. The receiving apparatus can estimate the channel by measuring the pilot signals transmitted by the transmitting apparatus and comparing the measurements with the known transmitted signals.

In some case, two or more transmitting apparatus may transmit pilot signals on certain locations, and one or more receiving apparatus may receive the pilot signals on the certain locations. In this case, pilot signal collision of the two or more transmitting apparatus happens on the certain locations.

In some case, one or more transmitting apparatus may transmit pilot signals on certain locations, and two or more receiving apparatus may receive the pilot signals on the certain locations. In this case, pilot signal collision of the two or more receiving apparatus happens on the certain locations.

### SUMMARY

Embodiments of the present application provide a communication method and a communication apparatus. The technical solutions may solve the pilot signal collision problem.

According to a first aspect, an embodiment of the present application provides a communication method, and the method could be performed by a communication device (that is transmitting apparatus, for example, a network device) or a chip in the communication device. The method includes: transmitting first information indicating information of a common pilot signal, where the common pilot signal is being transmitted on a first resource unit, where pilot signal collision of different communication devices happens at least on the first resource unit; transmitting the common pilot signal on the first resource unit.

According to the above technical solution, if the pilot signal collision of different communication devices is on a resource unit (for example, the first resource unit), a transmitting apparatus could transmit the common pilot signal on the first resource unit instead of a pilot signal assigned to the different communication devices. Therefore, for example, the different communication devices could receive the common pilot signal on the first resource unit, and perform channel estimation with the received pilot signal (including the common pilot signal). According to this solution, on the one hand, it could solve the problem of pilot signal collision, and on the other hand, it could also ensure channel estimation performance.

In a possible design, the information of the common pilot signal comprises one or more of: location information of the common pilot signal, value of the common pilot signal, antenna port index assigned to the common pilot signal, and transmission power of the common pilot signal.

According to the above technical solution, the information of the common pilot signal as above could be informed, and the different communication devices could receive the common pilot signal based on this information.

In a possible design, the different communication devices comprises a first communication device; the information of the common pilot signal is determined based on information of a first pilot signal assigned to the first communication device.

According to the above technical solution, the information of the common pilot signal is determined based on information of a pilot signal assigned to a collision communication device on the location of the pilot signal collision.

In a possible design, the information of the common pilot signal is the same as the information of the first pilot signal.

According to the above technical solution, the information of the common pilot signal is the same as the information of the pilot signal assigned to a collision communication device on the location of the pilot signal collision. This solution is simple and easy to implement.

In a possible design, the transmitting first information comprises: transmitting the first information to one or more communication devices other than the first communication device among the different communication devices.

According to the above technical solution, because the information of the common pilot signal is the same as the information of the pilot signal assigned to the first communication device, the transmitting apparatus does not need to inform the first communication device the information of the common pilot signal, thereby saving signaling overheads.

In a possible design, the information of the common pilot signal is determined based on the first resource unit and a relationship, where the relationship indicates information of pilot signal assigned to the first resource unit.

According to the above technical solution, the information of the common pilot signal could be determined from a location information of pilot signal collision (for example, first resource unit) as defined when pilot signal collision happens.

In a possible design, the method further comprises: transmitting second information indicating the relationship.

In a possible design, the information of the common pilot signal is pre-defined.

In a possible design, the method further comprises: transmitting pilot signals on M resource unit(s), where the M resource unit(s) exclude a second resource unit different from the first resource unit, where the pilot signal collision of the different communication devices is further on the second resource unit, M≥1.

According to the above technical solution, if the pilot signal collision of different communication devices is on a resource unit (for example, the second resource unit), the transmitting apparatus could transmit pilot signals on the M resource unit(s) excluding the second resource unit. According to this solution, it could solve the problem of pilot signal collision.

In a possible design, the method further comprises: transmitting third information indicating the second resource unit.

According to the above technical solution, the transmitting apparatus could inform the information about a location where no signal is transmitted.

In a possible design, the third information comprises one or more of: number of locations of the pilot signal collision, location information of the second resource unit, and indication of no signal on the second resource unit.

In a possible design, the method further comprises: transmitting configuration information of first pilot signal, wherein the configuration information of the first pilot signal is determined based on configuration information of second pilot signal, the first pilot signal corresponds to second communication device, the second pilot signal corresponds to third communication device.

According to the above technical solution, the transmitting apparatus could determine the configuration information of the first pilot signal for a communication device based on the configuration information of the second pilot signal for another communication device. For example, the configuration information of the first pilot signal and the configuration information of the second pilot signal could result in no or less locations of pilot collision. According to this solution, it could avid or mitigate pilot signal collision problem.

In a possible design, the configuration information of the first pilot signal comprises: resource allocation options of the first pilot signal, and/or, a pilot pattern of the first pilot signal.

In a possible design, the resource allocation options of the first pilot signal comprises one or more of: resource allocation, resource block (RB) allocation, and transmission time interval (TTI) allocation.

In a possible design, the method further comprises: transmitting related information of the pilot signal collision, where the related information of the pilot signal collision comprises one or more of: a location of the pilot signal collision, and an identifications of communication devices scheduled to receive pilot signal on the location of the pilot signal collision.

According to the above technical solution, the transmitting apparatus could inform the related information of the pilot signal collision to related communication devices, the related communication devices could receive pilot signal and perform channel estimation based on this information.

In a possible design, the method further comprises: generating pilot patterns for the different communication devices; identifying the first resource unit by comparing the pilot patterns.

According to the above technical solution, the transmitting apparatus could generate communication device specific pilot pattern for every communication device scheduled for transmission on a certain radio resource, and determine location of the pilot signal collision by comparing the pilot patterns.

According to a second aspect, an embodiment of the present application provides a communication method, and the method could be performed by a communication device (that is, a receiving apparatus, for example, a user equipment) or a chip in the communication device. The method includes: receiving first information indicating information of a common pilot signal, where the common pilot signal is being transmitted on a first resource unit, where pilot signal collision of different communication devices happens at least on the first resource unit; receiving the common pilot signal on the first resource unit.

In a possible design, the information of the common pilot signal comprises one or more of: location information of the common pilot signal, a value of the common pilot signal, an antenna port index assigned to the common pilot signal, and a transmission power of the common pilot signal.

In a possible design, the different communication devices comprises a first communication device; the information of the common pilot signal is determined based on information of a first pilot signal assigned to the first communication device.

In a possible design, the information of the common pilot signal is the same as the information of the first pilot signal.

In a possible design, the information of common pilot signal is determined based on the first resource unit and a relationship, where the relationship indicates information of pilot signal assigned to the first resource unit.

In a possible design, the method further comprises: receiving second information indicating the relationship.

In a possible design, the information of the common pilot signal is pre-defined.

In a possible design, the method further comprises: receiving pilot signals on M resource unit(s), where the M resource unit(s) exclude a second resource unit different from the first resource unit, where the pilot signal collision of the different communication devices is further on the second resource unit, M≥1.

In a possible design, the method further comprises: receiving third information indicating the second resource unit.

In a possible design, the third information comprises one or more of: number of locations of the pilot signal collision, location information of the second resource unit, and indication of no signal on the second resource unit.

In a possible design, the method further comprises: receiving configuration information of first pilot signal, wherein the configuration information of the first pilot signal is determined based on configuration information of second pilot signal, the first pilot signal corresponds to second communication device, the second pilot signal corresponds to third communication device.

In a possible design, the configuration information of the first pilot signal comprises: resource allocation options of the first pilot signal, and/or, pilot pattern of the first pilot signal.

In a possible design, the resource allocation options of the first pilot signal comprises one or more of: resource allocation, resource block (RB) allocation, and transmission time interval (TTI) allocation.

In a possible design, the method further comprises: receiving related information of the pilot signal collision, where the related information of pilot signal collision comprises one or more of: a location of the pilot signal collision, and an identifications of communication devices scheduled to receive pilot signal on the location of the pilot signal collision.

Various implementations of the second aspect are methods corresponding to the various implementations of the first aspect. For the various implementations and the beneficial technical effects of the various implementations of the second aspect, reference may be made to the descriptions of the relevant implementations of the first aspect, which will not be repeated here.

According to a third aspect, an embodiment of the present application provides a communication method, and the method could be performed by a communication device (that is transmitting apparatus, for example, a network device or a user equipment) or a chip in the communication device. The method includes: transmitting or receiving third information indicating a second resource unit where pilot signal collision happens; and transmitting a pilot signal on M resource unit(s), where the M resource unit(s) excludes the second resource unit, and M≥1.

According to the above technical solution, if the pilot signal collision of different communication devices is on a resource unit (for example, the second resource unit), a transmitting apparatus could transmit pilot signals on M resource unit(s) excluding the second resource unit. According to this solution, it could solve the problem of pilot signal collision. Further, the transmitting apparatus could inform the information about a location where no signal is transmitted. A receiving apparatus could receive pilot signals on the M resource unit(s) excluding the second resource unit based on this information.

In a possible design, the third information comprises one or more of: number of locations of the pilot signal collision, location information of the second resource unit, and indication of no signal on the second resource unit.

In a possible design, the method further comprises: transmitting related information of the pilot signal collision, where the related information of pilot signal collision comprises one or more of: a location of the pilot signal collision, an identifications of communication devices scheduled to receive the pilot signal on the location of the pilot signal collision.

According to the above technical solution, the transmitting apparatus could inform the related information of the pilot signal collision to related communication devices, and the related communication devices could receive pilot signal and perform channel estimation based on this information.

In a possible design, the method further comprises: generating pilot patterns for different communication devices; identifying the second resource unit by comparing the pilot patterns.

According to the above technical solution, the transmitting apparatus could generate communication device specific pilot pattern for every communication device scheduled for transmission on a certain radio resource, and determine the location of the pilot signal collision by comparing the pilot patterns.

According to a fourth aspect, an embodiment of the present application provides a communication method, and the method could be performed by a communication device (that is receiving apparatus, for example, a network device or a user equipment) or a chip in the communication device. The method includes: transmitting or receiving third information indicating a second resource unit where pilot signal collision being happened; receiving a pilot signal on M resource unit(s), where the M resource unit(s) exclude the second resource unit, M≥1.

In a possible design, the third information comprises one or more of: number of locations of the pilot signal collision, location information of the second resource unit, and indication of no signal on the second resource unit.

In a possible design, the method further comprises: receiving related information of the pilot signal collision, where the related information of pilot signal collision comprises one or more one of the following: a location of the pilot signal collision, identifications of communication devices scheduled to receive the pilot signal on the locations of the pilot signal collision.

Various implementations of the fourth aspect are methods corresponding to the various implementations of the third aspect. For the various implementations and the beneficial technical effects of the various implementations of the fourth aspect, reference may be made to the descriptions of the relevant implementations of the third aspect, which will not be repeated here.

According to a fifth aspect, an embodiment of the present application provides a communication method, and the method could be performed by a communication device (that is receiving apparatus, for example, a network device or a user equipment) or a chip in the communication device. The method includes: receiving configuration information of a pilot signal indicating that the pilot signal is transmitted on N resource units, N≥1; receiving the pilot signal on the N resource units based on the configuration information of the pilot signal; performing channel estimation with the pilot signal received on M resource unit(s), where the M resource unit(s) exclude a third resource unit where pilot signal collision being happened, and the N resource units include the M resource unit(s) and the third resource unit, 1≥M<N.

According to the above technical solution, if the pilot signal collision of different communication devices is on a resource unit (for example, the third resource unit), the receiving apparatus could perform channel estimation with the pilot signal received on M resource unit(s) excluding the second resource unit. According to this solution, it could solve the problem of pilot signal collision and ensure the channel estimation performance.

In a possible design, where receiving power of the pilot signal on the M resource unit(s) is within the threshold range.

For example, the receiving power of the pilot signals on locations other than the M resource unit(s) among the N resource units outside the threshold range.

According to the above technical solution, the receiving apparatus could have the ability to identify the locations where the pilot signal is not transmitted when pilot signal collision happens. Specifically, the receiving apparatus could measure receiving power of the pilot signal received, and perform channel estimation with the pilot signal whose receiving power is within the threshold range.

In a possible design, the method further comprises: measuring receiving power of the pilot signal received.

According to a sixth aspect, an embodiment of the present application provides a communication method, and the method could be performed by a communication device (that is receiving apparatus or transmitting apparatus, for example, a network device) or a chip in the communication device. The method includes: transmitting configuration information of first pilot signal, the configuration information of the first pilot signal is determined based on configuration information of second pilot signal, the first pilot signal corresponds to first UE, the second pilot signal corresponds to second UE; transmitting or receiving the first pilot signal based on the configuration information of the first pilot signal.

According to the above technical solution, the network device could determine the configuration information of the first pilot signal for the first UE based on the configuration information of second pilot signal. For example, the configuration information of the first pilot signal could result in no or less locations of pilot collision. According to this solution, it could avid or mitigate pilot signal collision problem.

In a possible design, the configuration information of the first pilot signal includes a resource allocation options of the first pilot signal, and/or, pilot pattern of the first pilot signal.

In a possible design, the resource allocation options of the first pilot signal comprises one or more of: resource allocation, resource block (RB) allocation, and transmission time interval (TTI) allocation.

According to a seventh aspect, an embodiment of the present application provides a communication method, and the method could be performed by a communication device (that is, a receiving apparatus or a transmitting apparatus, for example, a user equipment) or a chip in the communication device. The method includes: receiving configuration information of first pilot signal, the configuration information of the first pilot signal is determined based on configuration information of second pilot signal, the first pilot signal corresponds to first UE, the second pilot signal corresponds to second UE; transmitting or receiving transmits or receives the first pilot signal based on the configuration information of the first pilot signal.

In a possible design, the configuration information of the first pilot signal includes a resource allocation options of the first pilot signal, and/or, pilot pattern of the first pilot signal.

In a possible design, the resource allocation options of the first pilot signal comprises one or more of: resource allocation, resource block (RB) allocation, and transmission time interval (TTI) allocation.

Various implementations of the seventh aspect are methods corresponding to the various implementations of the sixth aspect. For the various implementations and the beneficial technical effects of the various implementations of the seventh aspect, reference may be made to the descriptions of the relevant implementations of the sixth aspect, which will not be repeated here.

According to an eighth aspect, a communication apparatus is provided, configured to perform the method in any possible implementation of the foregoing aspects. Specifically, the apparatus includes a unit configured to perform the method in any possible implementation of the foregoing aspects.

According to a ninth aspect, another communication apparatus is provided, including a processor. The processor is coupled to a memory, and may be configured to execute one or more instructions in the memory, to implement the method in any possible implementation of the first aspect to the seventh aspect. The memory may be an on-chip storage unit inside the processor, or may be an off-chip storage unit that is coupled to the memory and that is located outside the processor. In a possible implementation, the apparatus further includes a memory. In a possible implementation, the apparatus further includes a communication interface, and the processor is coupled to the communication interface.

In a possible design, the communication apparatus may be a transmitting apparatus (for example, a network device or a user equipment), may be a chip, a circuit, or a processing system configured in the transmitting apparatus, or may be a device including the transmitting apparatus.

In a possible design, the communication apparatus may be a receiving apparatus (for example, a network device or a user equipment), may be a chip, a circuit, or a processing system configured in the receiving apparatus, or may be a device including the receiving apparatus.

According to a tenth aspect, a computer-readable storage medium is provided. The computer readable-storage medium stores a computer program, and when the computer program is executed by a communication apparatus, the communication apparatus is enabled to implement the method in any possible implementation of the foregoing aspects.

According to an eleventh aspect, a computer program product including one or more instructions is provided. When the instructions are executed by a computer, a communication apparatus is enabled to implement the method in any possible implementation of the foregoing aspects.

According to a twelfth aspect, a communication system is provided, including the foregoing transmitting apparatus and the foregoing receiving apparatus.

### DESCRIPTION OF THE DRAWINGS

FIG. 1(a)-FIG. 1(d) are schematic diagram of an application scenario according to this application;

FIG. 2 is a schematic diagram of illustration of pilot signal collision;

FIG. 3 is a schematic flowchart of a communication method 300 according to an embodiment of this application;

FIG. 4 is a schematic diagram of illustration for solving pilot signal collision in downlink;

FIG. 5 is a schematic flowchart of a communication method 500 according to an embodiment of this application;

FIG. 6 is a schematic flowchart of a communication method 600 according to an embodiment of this application;

FIG. 7 is another schematic diagram of illustration for solving pilot signal collision in downlink;

FIG. 8 is a schematic diagram of illustration for solving pilot signal collision in uplink;

FIG. 9 is a schematic block diagram of a communication apparatus according to an embodiment of this application;

FIG. 10 is a schematic block diagram of another communication apparatus according to an embodiment of this application;

FIG. 11 is a schematic diagram of illustration of pilot collision;

FIG. 12 is a schematic diagram of illustration of method A for solving pilot collision in downlink;

FIG. 13 is a schematic diagram of method B, C and D for solving pilot collision in downlink;

FIG. 14 is a schematic diagram of gNB to UE2 signaling example;

FIG. 15 is a schematic diagram of method E and F for solving pilot collision in uplink; and

FIG. 16 is a schematic diagram of gNB to UE2 signaling example.

### DETAILED DESCRIPTION OF THE ILLUSTRATIVE EMBODIMENTS

The following describes technical solutions of the present application with reference to the accompanying drawings.

The technical solutions in embodiments of this application may be applied to Multiple input multiple-output (MIMO) technology. And the technical solutions in embodiments of this application may be applied to various communication systems, such as a fifth generation (5G) wireless communication system, a new ratio (NR) wireless communication system, a Long Term Evolution (LTE) system, an LTE frequency division duplex (FDD) system, an LTE time division duplex (TDD) system, a wireless local area network (WLAN), a satellite communication system, or other evolving communication systems, such as a sixth generation (6G) wireless communication system.

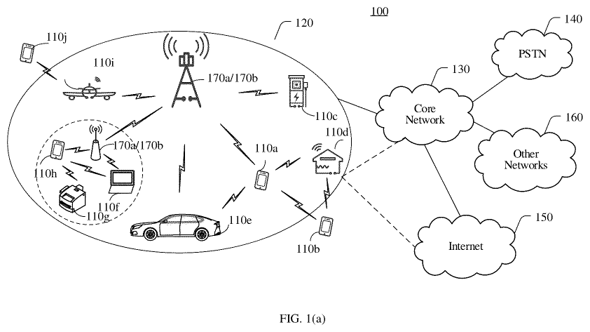

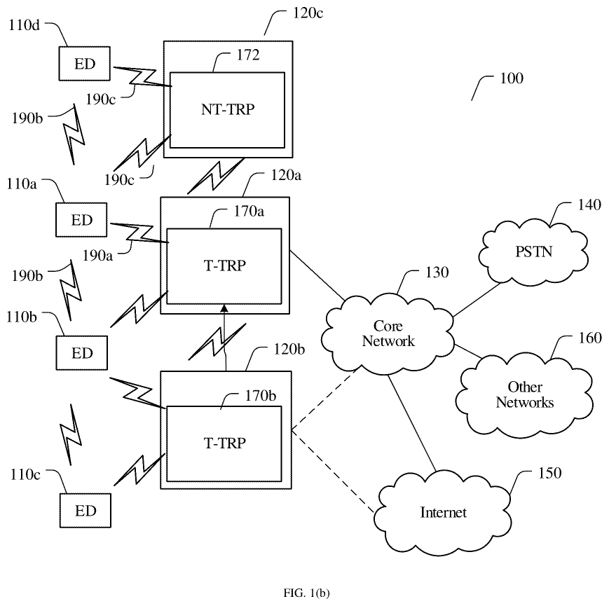

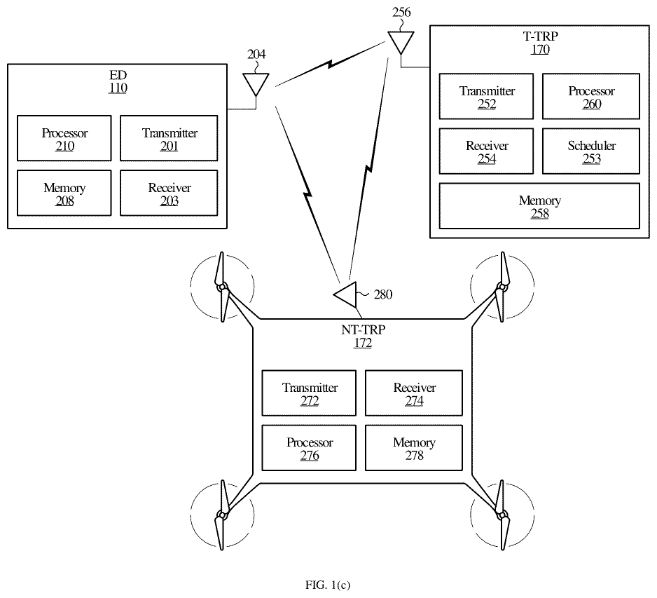

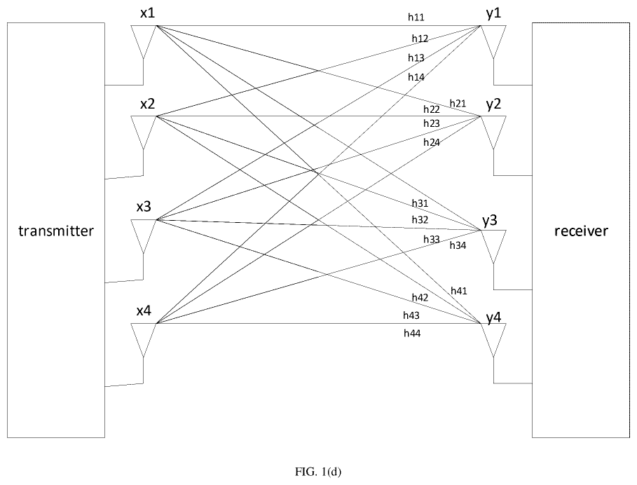

For ease of understanding the embodiments of this application, a communication system shown in FIG. 1(a)-FIG. 1(d) are used as an example to describe in detail a communication system to which the embodiments of this application are applicable.

Referring to FIG. 1(a), as an illustrative example without limitation, a simplified schematic illustration of a communication system is provided. The communication system 100 includes a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 includes a public switched telephone network (PSTN) 140, the internet 150, and other networks 160.

Referring to FIG. 1(b), FIG. 1(b) illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

Referring to FIG. 1(c), FIG. 1(c) illustrates another example of an ED no and a base station 170a, 170b and/or 170c. The ED no is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 1(c), a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitting apparatus 201 and a receiving apparatus 203 coupled to one or more antennas 204. Only one antenna 204 is illustrated. One, some, or all of the antennas may alternatively be panels. The transmitting apparatus 201 and the receiving apparatus 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1(a). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiving apparatus 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitting apparatus 201 and/or receiving apparatus 203. Although not illustrated, the memory 208 may form part of the processor 210.

The processor 210, and the processing components of the transmitting apparatus 201 and receiving apparatus 203 may each be implemented by the same or different one or more processors that are configured to execute instructions stored in a memory (e.g. in memory 208). Alternatively, some or all of the processor 210, and the processing components of the transmitting apparatus 201 and receiving apparatus 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), radio unit (RU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

The CU (or CU-control plane (CP) and CU-user plane (UP)), DU or RU may be known by other names in some implementations. For example, in open RAN (ORAN) system, the CU may also be referred to as open CU (0-CU), DU may also be referred to as open DU (O-DU), CU-CP may also be referred to open CU-CP (O-CU-CP), CU-UP may also be referred to as open CU-UP (O-CU-CP), and RU may also be referred to open RU (0-RU). Any one of the CU (or CU-CP, CU-UP), DU, or RU could be implemented through a software module, a hardware module, or a combination of software and hardware modules.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitting apparatus 252 and at least one receiving apparatus 254 coupled to one or more antennas 256. Only one antenna 256 is illustrated. One, some, or all of the antennas may alternatively be panels. The transmitting apparatus 252 and the receiving apparatus 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitting apparatus 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitting apparatus 252 and/or receiving apparatus 254. Also, although not illustrated, the processor 260 may implement the scheduler 253. Although not illustrated, the memory 258 may form part of the processor 260.

The processor 260, the scheduler 253, and the processing components of the transmitting apparatus 252 and receiving apparatus 254 may each be implemented by the same or different one or more processors that are configured to execute instructions stored in a memory, e.g. in memory 258. Alternatively, some or all of the processor 260, the scheduler 253, and the processing components of the transmitting apparatus 252 and receiving apparatus 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitting apparatus 272 and a receiving apparatus 274 coupled to one or more antennas 280. Only one antenna 280 is illustrated. One, some, or all of the antennas may alternatively be panels. The transmitting apparatus 272 and the receiving apparatus 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitting apparatus 272 and/or receiving apparatus 274. Although not illustrated, the memory 278 may form part of the processor 276.

The processor 276 and the processing components of the transmitting apparatus 272 and receiving apparatus 274 may each be implemented by the same or different one or more processors that are configured to execute instructions stored in a memory, e.g. in memory 278. Alternatively, some or all of the processor 276 and the processing components of the transmitting apparatus 272 and receiving apparatus 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

As mentioned earlier, the technical solutions in embodiments of this application may be applied to Multiple input multiple-output (MIMO). MIMO technology allows an antenna array of multiple antennas to perform signal transmissions and receptions to meet high transmission rate requirement. The above ED 110 and T-TRP 170, and/or NT-TRP use MIMO to communicate over the wireless resource blocks. MIMO utilizes multiple antennas at the transmitting apparatus and/or receiving apparatus to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiving apparatus connected to a receive (Rx) antenna, a transmitting apparatus connected to transmit (Tx) antenna, and a signal processor connected to the transmitting apparatus and the receiving apparatus. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target. The receiving apparatus could be an ED (i.e. ED110) and the transmitting apparatus could be a T-TRP or NT-TRP (i.e. T-TRP 170 or NT-TRP 172), or the receiving apparatus could be a T-TRP or NT-TRP (i.e. T-TRP 170 or NT-TRP 172) and the transmitting apparatus could be an ED (i.e. ED110).

Referring to FIG. 1(d), as an illustrative example without limitation, a simplified schematic illustration of a communication scenario is provided. A transmitting apparatus is connected to four TX antennas, x1 to x4, a receiving apparatus is connected to four RX antennas, y1 to y4, and a transmission channel may be formed between each TX antenna and each RX antenna. For example, an RF signal transmitted through x1 may be received by y2 through channel h21. The RF signal transmitted through x3 may be received by y1 through channel h13.

In a MIMO system, to implement functions such as system synchronization, channel information feedback, and data transmission, channel estimation needs to be performed on an uplink channel or a downlink channel. Channel estimation refers to the process of reconstructing or restoring received signals to compensate for signal distortion caused by channel fading and noise. In channel estimation, a reference signal predicted by a transmitting apparatus and a receiving apparatus may be used to track a change in the time domain and/or frequency domain of a channel, so as to reconstruct or restore a received signal. The reference signal may also be referred to as a pilot signal, a reference sequence or the like, and is described as a reference signal in the following for ease of understanding. The reference signal includes, for example, a channel state information-reference signal (CSI-RS), a sounding reference signal (SRS), a demodulation reference signal (DMRS), phase track reference signals (PT-RS), or cell reference signals (CRS). The reference signals listed above are merely examples, and shall not constitute any limitation on this application. This application does not exclude the possibility that other reference signals are defined in a future protocol to implement the same or similar function.

To facilitate understanding of the embodiments of this application, the CSI-RS is described in detail by example below. The CSI-RS is mainly used for downlink channel estimation corresponding to a physical antenna port. For example, a receiving apparatus (i.e. a UE) may perform channel estimation on each physical antenna port based on a CSI-RS sent by a transmitting apparatus ((i.e. a base station), to feedback channel state information (CSI) based on a channel estimation result. The CSI may include related information such as a channel quality indicator (channel quality indicator, CQI), a precoding matrix indicator (precoding matrix indicator, PMI), a layer indicator (layer indicator, LI), and a rank indicator (rank indicator, RI). The CSI is used to reconstruct or precode the downlink channel. In some implementations, a process in which the base station obtains CSI may include: sending, by the base station, a reference signal to the UE; obtaining, by the UE, an estimated CSI value according to the received reference signal, selecting a precoding vector from a codebook according to the estimated CSI value, and feedback the index of the precoding vector to the base station; the base station determines a CSI reconstruction value with reference to the index of the precoding vector. The CSI reconstruction value can be a CSI closest to the true value of the CSI that can be obtained by the base station.

In an implementation, a transmitting apparatus maps a sequence of reference signals to certain physical resources, and transmit the reference signals over the certain physical resources, where the sequence of reference signals and the physical resource are known to both the transmitting apparatus and the receiving apparatus receiving the reference signals. Thus, the receiving apparatus could perform channel estimation based on the received reference signals.

For ease of understanding of the embodiments of this application, UE is used to represent the ED as an embodiment herein after, and the following briefly describes several terms used in this application.

### 1) Pilot

In a wireless communication system, it is important to acquire the characteristics of a channel. In order to estimate a channel, pilot signals known to both transmitting apparatus and receiving apparatus are transmitted. Pilot signals are a series of reference signals of which the locations and values are known to both transmitting apparatus and receiving apparatus. Pilot signals are transmitted by one or more transmitting apparatus to one or more receiving apparatus, which are used to perform channel estimation. For example, the receiving apparatus can estimate the channel by measuring the pilot signals transmitted by the transmitting apparatus and comparing the measurements with the known transmitted signals. The process of channel estimation is to figure out the channel response (channel coefficients, channel status) or reconstruct a channel.

The pilot signal may also be referred to as a reference signal (RS), a reference sequence, or the like. In the embodiments of this application, the pilot signal may be a pilot signal used for channel measurement. For example, the pilot signal may be a CSI-RS used for downlink channel measurement, or may be a sounding reference signal (SRS) used for uplink channel measurement. The pilot signals listed above are merely examples, and shall not constitute any limitation on this application. This application does not exclude a possibility that another pilot signal is defined in a future protocol to implement a same or similar function.

The process of transmitting the pilot signal described below may be performed by a network device, or may be performed by a UE. The process of measuring a channel may be performed by the UE when the network device transmits the pilot signal, and may be performed by the network device when the UE transmits the pilot signal. For ease of description, a device that transmits the pilot signal is herein after referred to as a transmitting apparatus and a device that measures a channel based on the pilot signal is herein after referred to as a receiving apparatus.

### 2) Pilot Pattern

A pilot pattern is defined as a series of locations where reference signals are transmitted to perform channel estimation. The pilot pattern may be also referred to as a location of a reference signal resource. A location is generally composed of indication information from three dimensions of time, frequency and space. But not all conditions require indication information in three dimensions to be specified. For example, a dimension of frequency is presented when orthogonal frequency division multiplexing (OFDM) is used. A dimension of space is presented when multiple-input multiple-output (MIMO) is adopted in system.

The frequency dimension could be represented by a frequency domain unit, which may include but is not limited to a subcarrier, a subband, a resource block (RB), a resource block group (RBG) and etc. In an implementation, the location in a frequency direction could be represented as a subcarrier index, a RB index and a RBG index, etc.

The time dimension could be represented by a time domain unit, which may include but is not limited to a symbol, an OFDM symbol, a slot and a transmission time interval (TTI). In an implementation, the location in a time direction could be represented as an OFDM symbol index, a time symbol index, a TTI index, etc.

The spatial dimension could be represented by a spatial domain unit, which may be referred to as a port. The port may be understood as a virtual antenna identified by a receiving apparatus. In the embodiments of this application, a port may be an antenna port. In an implementation, the location in a spatial direction could be represented as an antenna port index.

To facilitate understanding of an embodiment of this application embodiment, in the following exemplary description, an OFDM symbol index is used to represent a time domain unit, a subcarrier index is used to represent a frequency domain unit and a port index is used to represent a spatial domain unit.

### 3) Sparse Pilot Pattern Generation Method

In a 5G NR system, pilots are distributed densely enough along a frequency direction to keep up with varying radio channels. In case of multiple antenna ports, these pilots must be distributed densely enough along the frequency direction for every single port. If we continue to apply a 5G NR scheme into a T-MIMO system, an increasing number of antenna ports of T-MIMO would linearly increase the total number of the pilots. The very large number of antenna ports of T-MIMO would require huge amounts of pilots, and pilots become a heavy overhead of time-frequency radio resources, which should have been configured to data transmission. Furthermore, even though a 5G-NR's cyclic-shift-based multiplexing method could alleviate the overhead to some degree, the total tolerable number of the ports multiplexed on the same subcarrier can get easily saturated by inherent multiplexing interferences.

Some methods can be used to solve the problem that a large amount of time-frequency radio resources is occupied by pilots in T-MIMO systems by using traditional 5G-NR methods for pilot allocation. In an implementation, a method is used to generate a non-uniform and very sparse pilot pattern and achieve similar channel estimation performance. In another implementation, a method is used to generate a pseudo-random sparse pilot. Generally, the number of pilots by these methods is far less than the number of pilots required by 5G-NR method.

The sparse pilot pattern generation method will greatly reduce the number of pilots used and guarantee the channel estimation quality at the same time.

When pilots with a sparse pilot pattern are used, the more pilot signals contribute to performing channel estimation, the more accurate the estimated channel response to the real channel response is, and the better channel estimation quality is. The sparse pilot pattern generation method will usually generate more pilots than required by ensuring the minimum channel estimation quality. Therefore, applying the sparse pilot pattern generation method is not sensitive to pilot signal collision because it can tolerate a certain percentage of pilot missing (not transmitted, not received or not measured) in a receiving apparatus side as long as the missing pilot is below a tolerable percentage. The receiving apparatus is still able to estimate or reconstruct the entire channel response without significant performance loss when some transmitted pilots are not considered in a channel estimation procedure. For example, the sparse pilot pattern generation method could refer to the following patents application: PCT/CN2022/126878, PCT/CN2022/094688.

### 4) Pilot Signal Collision

During the transmission, a system may schedule different UEs to perform transmission on a certain radio resource, such as one time symbol (e.g., OFDM symbol), several RBs over several time symbols and etc. By using the sparse pilot pattern method, there will be a pilot pattern (on which a subcarrier index, an antenna port index and/or a time symbol index to transmit pilot signals) assigned to each scheduled UE as defined in specification. Unlike 5G-NR, the sparse pilot pattern assigned to different UE is determined individually (UE may not refer to pilot patterns of other UEs when it determines its own pilot pattern). Once mapping all the pilot patterns of different scheduled UEs together, it could be found out that there may be more than one UE configured to transmit/receive a pilot signal on the same resource location, for example two UEs configured to transmit a pilot signal on the same subcarrier (or RE) at the same OFDM symbol. Such is called pilot signal collision.

Pilot signal collision means different UEs are scheduled to transmit pilot signal on the same resource location (e.g., same subcarrier at the same OFDM symbol). Pilot signal collision in downlink means pilot signals to be transmitted to two or more UEs are going to be transmitted at the same subcarrier and at the same OFDM symbol. Pilot signal collision in uplink means pilot signals from two or more UEs are going to be transmitted at the same subcarrier and at the same OFDM symbol. an antenna port in pilot signal collision is not mentioned, since there will be only one antenna port active on one subcarrier at one OFDM symbol. Therefore, to identify pilot signal collision, the application focus on the location defined by frequency dimension and time dimension.

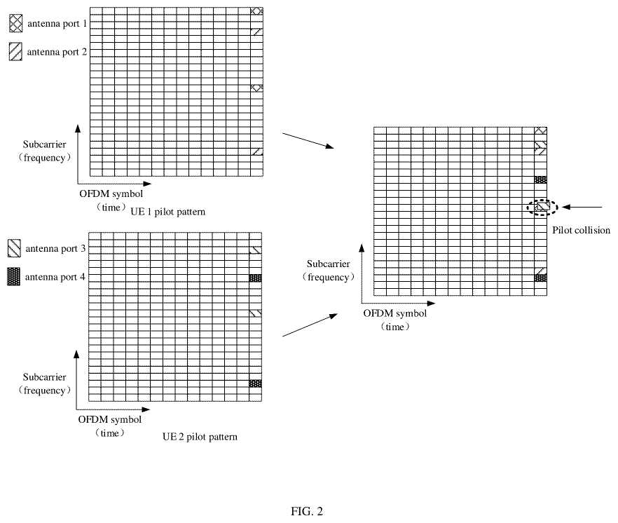

Referring to FIG. 2, FIG. 2 is a schematic diagram of illustration of pilot signal collision. As illustrated in FIG. 2, the upper left part shows a UE1 specific pilot pattern and the lower left part shows a UE2 specific pilot pattern. When UE1 and UE2 are scheduled to transmit pilots at the same time, we may find that one pilot signal in the UE1 pilot pattern overlaps with one pilot signal in the UE2 pilot pattern. Pilot signal collision happens at that location with a certain subcarrier index and a certain OFDM symbol index, as shown in the right part in FIG. 2.

It can be seen from above, there is still a remaining issue with applying the sparse pilot generation method in the system: pilot signal collision may happen. The present application presents the methods and solutions to handle the pilot signal collision problem.

In view of this, the embodiments of this application provide a method to solve the problem when multiple UEs are configured to transmit pilot signals on the same location in downlink and uplink.

The following describes the embodiments of this application in detail with reference to the accompanying drawings.

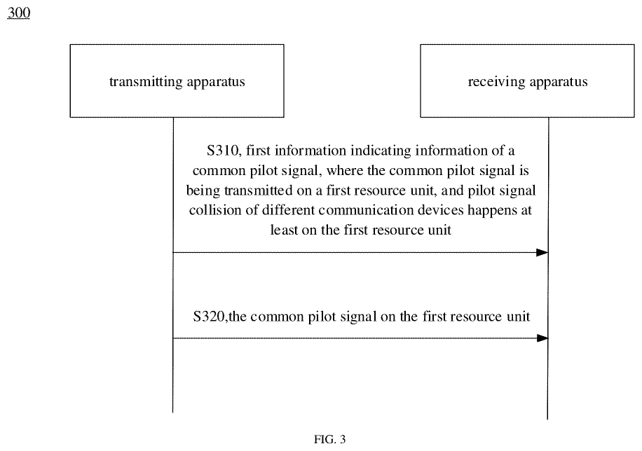

Referring to FIG. 3, FIG. 3 is a schematic flowchart of a communication method 300 according to an embodiment of this application. The communication method 300 may be applied to the communication system 100 shown in FIG. 1(a). The communication method 300 may be applied to downlink transmission.

S310, a transmitting apparatus transmits first information indicating information of a common pilot signal, where the common pilot signal is being transmitted on a first resource unit, and pilot signal collision of different communication devices happens at least on the first resource unit.

Correspondingly, one or more receiving apparatus receives the first information.

The different communication devices are different receiving apparatus.

S320, the transmitting apparatus transmits the common pilot signal on the first resource unit. Correspondingly, one or more receiving apparatus receives the common pilot signal on the first resource unit.

Based on the foregoing technical solution, the transmitting apparatus could determine locations of pilot signal collision, and then the transmitting apparatus could make decision on where (on which locations of pilot signal collision) to transmit the common pilot signal. Then the transmitting apparatus could inform a related receiving apparatus of the information of the common pilot signal.

In the method 300, for example, the transmitting apparatus is a network device, and the receiving apparatus is a UE or a network device.

For example, the transmitting apparatus could broadcast, multicast or unicast the information of the common pilot signal by using signaling in downlink. Correspondingly, receiving apparatus could receive and interpret this signaling, and then perform pilot signal processing and channel estimation as defined in its own system.

In a possible implementation, the receiving apparatus could ignore the pilot signal transmitted on the location of the pilot signal collision and perform channel estimation without the pilot signal transmitted on these locations of pilot signal collision. Specifically, the receiving apparatus could ignore the common pilot signal transmitted on the first resource unit and perform channel estimation without pilot signal transmitted on the first resource unit.

In another possible implementation, receiving apparatus could measure pilot signal transmitted on the location of the pilot signal collision and perform channel estimation by determining the pilot signal transmitted on the location of the pilot signal collision. Specifically, receiving apparatus could measure the common pilot signal transmitted on the first resource unit and perform channel estimation by determining the pilot signal transmitted on the first resource unit.

The resource unit includes a time domain unit and/or a frequency domain unit. For example, a resource unit includes a time domain unit (for example, an OFDM symbol) and/or a frequency domain unit (for example, a subcarrier).

The first resource unit is a location where pilot signals of the different communication devices suffer from pilot signal collision. Specifically, there are two or more receiving apparatus configured to transmit/receive a pilot signal on the first resource unit, for example two or more receiving apparatus configured to transmit a pilot signal on the same subcarrier (or RE) at the same OFDM symbol.

In the method 300, the common pilot signal is used to represent a pilot signal that is transmitted on the location of the pilot signal collision. The common pilot signal is merely a general name, and does not limit the protection scope of embodiments of this application.

The first information indicates information of the common pilot signal.

In a possible implementation, the first information is directly the information of the common pilot signal.

In another possible implementation, the first information is other information which could be used to determine information of the common pilot signal, where the other information is associated with the information of the common pilot signal.

In some embodiments, the information of common pilot signal may include one or more of: location of the common pilot signal, a value of the common pilot signal, an antenna port index assigned to the common pilot signal, a transmission power used to transmit the common pilot signal, etc. In this application, for brevity, the value of a pilot signal is referred to pilot value.

The location of the common pilot signal is the location of the first resource unit. For example, the location of the common pilot signal includes a frequency domain resource and/or a time domain resource transmitted the common pilot signal.

When the transmitting apparatus determines the pilot signal collision of the different communication devices happens on the first resource unit, the location of the common pilot signal could be determined to be the location of the first resource unit. Then the transmitting apparatus could determine the other information of the common pilot signal, for example, the value of the common pilot signal, and the antenna port index assigned to the common pilot signal.

The value of the common pilot signal is a common pilot value.

The common pilot signal may be designed in any one of the following manners.

Manner #A: The information of the common pilot signal could be determined based on the first resource unit and a relationship, wherein the relationship indicates information of a pilot signal assigned to the first resource unit.

The relationship could be known both to the transmitting apparatus and the receiving apparatus. The relationship could be pre-defined, or received from the other apparatus. For example, for the receiving apparatus, the receiving apparatus receives the relationship from the transmitting apparatus. Specifically, the transmitting apparatus transmits second information indicating the relationship, and the receiving apparatus received the second information. In a possible implementation, the second information is the relationship. In another possible implementation, the second information is other information which could be used to determine the relationship.

The information of the common pilot signal includes the common pilot value, and/or, the antenna port index assigned to the common pilot signal, and the first resource unit could be referred by an index in a frequency and/or time direction. Therefore, the common pilot value and/or the antenna port index assigned to the common pilot signal could be determined based on a subcarrier index in a frequency direction and/or an OFDM symbol index in a time direction.

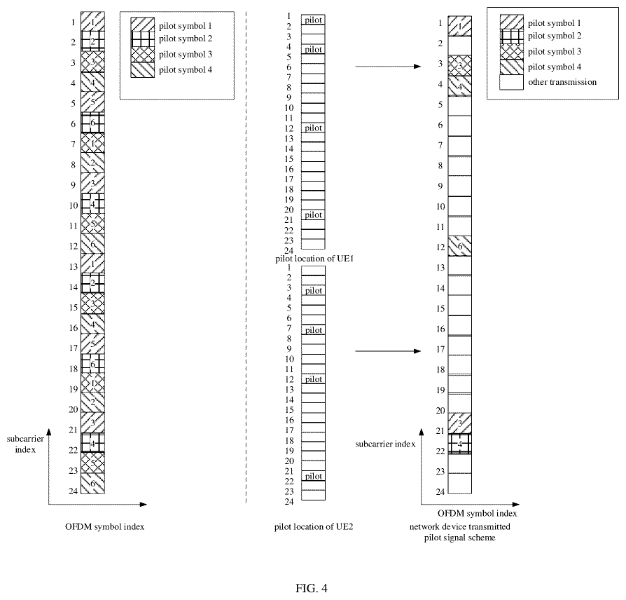

As shown in the left part of FIG. 4, the number on each subcarrier is the antenna port index assigned to transmit a pilot signal. For example, assume subcarrier index 1 has a relationship with antenna port index 1 and pilot value 1, if there is a pilot signal be transmitted on the subcarrier index 1, a transmitting apparatus is going to use the antenna port index 1 to transmit the pilot value 1 on this location. Assume subcarrier index 18 has a relationship with antenna port index 6 and pilot value 2, if there is a pilot signal be transmitted on the subcarrier index 18, a transmitting apparatus is going to use the antenna port index 6 to transmit the pilot value 2 on this location. As shown in the left part of FIG. 4, on each location of this radio resource, there is pre-defined pilot value and antenna port index assigned to transmit a pilot signal on a subcarrier index.

There are three examples.

Example 1: The information of the common pilot signal includes the common pilot value, and the antenna port index assigned to the common pilot signal. In this Example 1, the common pilot value and the antenna port index assigned to the common pilot signal could be determined based on the first resource unit and a relationship, wherein the relationship indicates a pilot value and an antenna port index assigned to the first resource unit.

Specifically, the transmitting apparatus could determine a pilot value and an antenna port index assigned to transmit the pilot signal based on the location of the pilot signal.

For example, a pilot value and an antenna port are associated with the location of the pilot signal. In other words, the pilot value is pre-defined on each location, and the antenna port assigned to transmit the pilot signal is also pre-defined on each location. Therefore, when the transmitting apparatus transmits the common pilot signal on a pilot signal collision location, it only needs to get the information of the pilot signal collision location in a frequency and/or time direction of each scheduled receiving apparatus.

For example, the location of the pilot signal could be referred to by an index in frequency, and relationship between a pilot value, an antenna port, and the location of the pilot signal are shown in the following Table 1.

TABLE 1

| | | the location of |
|---|---|---|
| pilot value | antenna port | the pilot signal |
| pilot value#1 | antenna port#1 | subcarrier #1 |
| pilot value#2 | antenna port#2 | subcarrier #2 |
| pilot value#3 | antenna port#3 | subcarrier #3 |

As shown in Table 1, if there is a pilot signal to be transmitted on subcarrier #1, based on the relationship (that is Table 1), a transmitting apparatus could use antenna port #1 to transmit pilot value #1 on this location. If there is a pilot signal to be transmitted on subcarrier #2, based on the relationship (that is Table 1), a transmitting apparatus could use antenna port #2 to transmit pilot value #2 on this location. If there is a pilot signal to be transmitted on subcarrier #3, based on the relationship (that is Table 1), a transmitting apparatus could use antenna port #2 to transmit pilot value #3 on this location.

According to the method 300, for example, if the first resource unit is the subcarrier #1, that is, the pilot signal collision of different communication devices happens at least on the subcarrier #1, based on the relationship (that is Table 1), the transmitting apparatus could use antenna port #1 to transmit pilot value #1 on the first resource unit. If the first resource unit is the subcarrier #2, that is, the pilot signal collision of different communication devices happens at least on the subcarrier #2, based on the relationship (that is Table 1), the transmitting apparatus could use antenna port #2 to transmit pilot value #2 on the first resource unit. If the first resource unit is the subcarrier #3, that is, the pilot signal collision of different communication devices happens at least on the subcarrier #3, based on the relationship (that is Table 1), the transmitting apparatus could use antenna port #3 to transmit pilot value #3 on the first resource unit.

Example 2: The information of the common pilot signal includes the common pilot value. In this Example 2, the common pilot value could be determined based on the first resource unit and a relationship, wherein the relationship indicates a pilot value assigned to the first resource unit.

Specifically, the transmitting apparatus could determine the pilot value based on some configured parameters. In this case, for example, the antenna port assigned to the common pilot signal could be pre-defined.

For example, the location of the pilot signal could be referred to by an index in frequency, and relationship between pilot value and the location of the pilot signal shown in the following Table 2.

TABLE 2

| | the location of |
|---|---|
| pilot value | the pilot signal |
| pilot value#1 | subcarrier #1 |
| pilot value#2 | subcarrier #2 |
| pilot value#3 | subcarrier #3 |

For example, as shown in Table 2, if there is a pilot signal to be transmitted on subcarrier #1, based on the relationship (that is Table 2), transmitting apparatus could transmit pilot value #1 on this location. If there is a pilot signal to be transmitted on subcarrier #2, based on the relationship (that is Table 2), transmitting apparatus could transmit pilot value #2 on this location. If there is a pilot signal to be transmitted on subcarrier #3, based on the relationship (that is Table 2), transmitting apparatus could transmit pilot value #3 on this location.

According to the method 300, for example, if the first resource unit is the subcarrier #1, that is, the pilot signal collision of different communication devices happens at least on the subcarrier #1, based on the relationship (that is Table 2), the transmitting apparatus could transmit pilot value #1 on the first resource unit. If the first resource unit is the subcarrier #2, that is, the pilot signal collision of different communication devices happens at least on the subcarrier #2, based on the relationship (that is Table 2), the transmitting apparatus could transmit pilot value #2 on the first resource unit. If the first resource unit is the subcarrier #3, that is, the pilot signal collision of different communication devices happens at least on the subcarrier #3, based on the relationship (that is Table 2), the transmitting apparatus could transmit pilot value #3 on the first resource unit.

Example 3: The information of the common pilot signal includes the antenna port index assigned to the common pilot signal. In this Example 3, the antenna port index assigned to the common pilot signal could be determined based on the first resource unit and a relationship, wherein the relationship indicates an antenna port index assigned to the first resource unit.

Specifically, the transmitting apparatus could determine antenna port assigned to transmit pilot signal based on some configured parameters. In this case, for example, the pilot value could be pre-defined.

For example, the location of the pilot signal could be referred by an index in frequency, and a relationship between the antenna port and the location of the pilot signal is shown in the following Table 3.

TABLE 3

| | the location of |
|---|---|
| antenna port | the pilot signal |
| antenna port#1 | subcarrier #1 |
| antenna port#2 | subcarrier #2 |
| antenna port#3 | subcarrier #3 |

For example, as shown in Table 3, if there is a pilot signal to be transmitted on subcarrier #1, based on the relationship (that is Table 3), a transmitting apparatus could use antenna port #1 to transmit the pilot signal on this location. If there is a pilot signal to be transmitted on subcarrier #2, based on the relationship (that is Table 3), a transmitting apparatus could use antenna port #2 to transmit the pilot signal on this location. If there is a pilot signal to be transmitted on subcarrier #3, based on the relationship (that is Table 3), a transmitting apparatus could use antenna port #2 to transmit the pilot signal on this location.

According to the method 300, for example, if the first resource unit is the subcarrier #1, that is, the pilot signal collision of different communication devices happens at least on the subcarrier #1, based on the relationship (that is Table 3), the transmitting apparatus could use antenna port #1 to transmit the common pilot signal on the first resource unit. If the first resource unit is the subcarrier #2, that is, the pilot signal collision of different communication devices happens at least on the subcarrier #2, based on the relationship (that is Table 3), the transmitting apparatus could use antenna port #2 to transmit the common pilot signal on the first resource unit. If the first resource unit is the subcarrier #3, that is, the pilot signal collision of different communication devices happens at least on the subcarrier #3, based on the relationship (that is Table 3), the transmitting apparatus could use antenna port #3 to transmit the common pilot signal on the first resource unit.

The content of Table 1-Table 3 is merely an example, and this embodiment of this application is not limited thereto. For example, the location of the pilot signal could be referred by an index in a time direction.

This method of determining a pilot value and/or an antenna port assigned to transmit a pilot signal could be applied to all the pilot signals transmitted from the transmitting apparatus. It means when multiple receiving apparatus are scheduled to transmit a pilot signal on a certain location defined by a subcarrier index and/or an OFDM symbol index, the pilot value and/or antenna port assigned to transmit the pilot signal could be the same for different receiving apparatus.

By using this Manner #A, the pilot signals transmitted to the receiving apparatus could be like what the receiving apparatus is expected as defined in a pilot pattern, and therefore, the receiving apparatus could perform normal pilot signal processing and channel estimation as if pilot signal collision doesn't occur. Furthermore, in this case, the receiving apparatus could determine information of the common pilot signal according to the configured parameters (such as the location of the pilot signal), and therefore the transmitting apparatus does not need to transmit the information of the common pilot signal to the receiving apparatus, which saves signaling overhead.

Manner #B: The information of the common pilot signal is determined based on information of a first pilot signal assigned to a first communication device.

The different communication devices (receiving apparatus) include the first communication device.

In a possible implementation, the information of the common pilot signal is the same as the information of the first pilot signal.

Specifically, the pilot value and/or antenna port index assigned to the common pilot signal could be the pilot value and the antenna port index of one receiving apparatus selected from multiple collision receiving apparatus on the location of the pilot signal collision.

The transmitting apparatus could determine a pilot value and an antenna port index assigned to transmit this common pilot signal on a location of pilot signal collision. By using Manner #B, the pilot value and the antenna port index assigned to transmit this pilot value could be the pilot value and the antenna port index of one receiving apparatus (the first communication device) selected from multiple collision receiving apparatus on the location of the pilot signal collision. The transmitting apparatus could inform the all of the receiving apparatus which conflict on the first resource unit, or, the transmitting apparatus could inform receiving apparatus which conflict on the first resource unit other than the first communication device of the information of common pilot signal.

By using this Manner #B, for the receiving apparatus, in some condition, receiving apparatus could ignore the pilot signal transmitted on the location of the pilot signal collision and perform channel estimation without a pilot signal transmitted on these locations of the pilot signal collision. In some condition, receiving apparatus could measure the pilot signal transmitted on the location of the pilot signal collision and perform channel estimation by determining the pilot signal transmitted on the location of the pilot signal collision.

Manner #C: The information of the common pilot signal is pre-defined.

For example, the pilot value and/or the antenna port index assigned to transmit this common pilot signal could be picked up from a set of predefined values known both to the transmitting apparatus and the receiving apparatus. The predefined values may include but be not limited to a pilot value, an antenna port index assigned to transmit the pilot value, a transmission power, etc. Instead of enumerate values, the transmitting apparatus could only need to indicate the index of selection from a set of predefined values in downlink signaling.

In the method 300, in some embodiments, the transmitting apparatus transmits related information of the pilot signal collision to the related receiving apparatus. For example, the transmitting apparatus obtains the related information of the pilot signal collision, and then transmits the related information of the pilot signal collision. The transmitting apparatus could broadcast, multicast or unicast the related information of the pilot signal collision by using signaling in downlink. The information of the common pilot signal and the related information of the pilot signal collision could be transmitted by using a same signaling or different signaling. This related information of the pilot signal collision will be described in detail in method 500.

The above method 300 is illustrated by transmitting the common pilot signal the first resource unit as an example, which is not limited. For example, the common pilot signal can also be transmitted on other resource units where pilot signal collision happens.

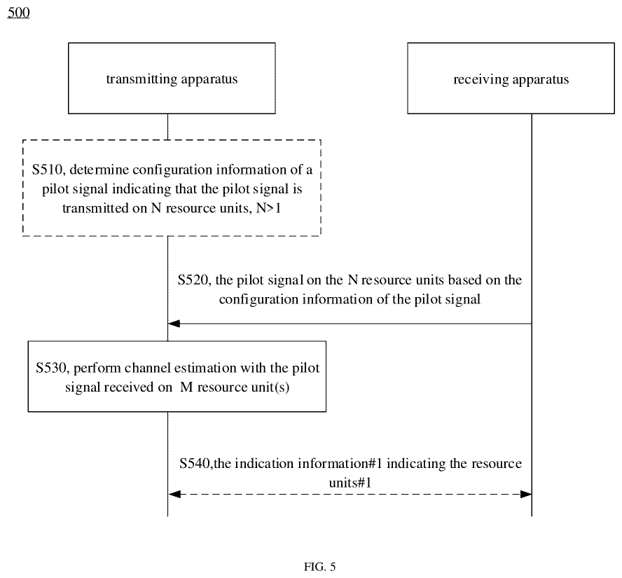

Referring to FIG. 5, FIG. 5 is a schematic flowchart of a communication method 500 according to an embodiment of this application. The method 500 may be applied to the communication system 100 shown in FIG. 1(a).

In some embodiments, S510, a receiving apparatus determines configuration information of a pilot signal indicating that the pilot signal is transmitted on N resource units, N>1.

A resource unit includes a time domain unit and/or a frequency domain unit. For example, a resource unit includes a time domain unit (for example, an OFDM symbol) and a frequency domain unit (for example, a subcarrier).

S520, the receiving apparatus receives the pilot signal on the N resource units based on the configuration information of the pilot signal from a transmitting apparatus.

Correspondingly, the transmitting apparatus transmits the pilot signal on the N resource units.

The receiving apparatus is a UE, and the transmitting apparatus is a network device or a UE. Or the receiving apparatus is a network device, and the transmitting apparatus is a UE or a network device.

S530, the receiving apparatus performs channel estimation with the pilot signal received on M resource units.

The M resource units excludes a resource unit #1, the resource unit #1 is location where pilot signal collision being happens, and the N resource units include the M resource unit(s) and the resource unit #1, 1≤M<N.

Based on the foregoing technical solution, the receiving apparatus could ignore the pilot signal transmitted on the location of the pilot signal collision and perform channel estimation without the pilot signal transmitted on these locations of the pilot signal collision. On the one hand, it could solve the problem of pilot signal collision, and on the other hand, it could also ensure channel estimation performance.

In some embodiments, the receiving apparatus obtains the related information of the pilot signal collision.

The related information of the pilot signal collision indicates that pilot signal collision happened on locations other than the M resource unit(s) among the N resource units. In some embodiments, the related information of the pilot signal collision includes one or more of: a location of the pilot signal collision, an identifications of communication devices scheduled to receive the pilot signal on the location of the pilot signal collision, an antenna port assigned to communication devices on the location of the pilot signal collision, and a pilot value allocated to communication devices on the location of the pilot signal collision.

The receiving apparatus obtains the related information of the signal collision in any one of the following manners:

Manner 1: The receiving apparatus determines the related information of the pilot signal collision by itself.

Manner 2: The receiving apparatus receives the related information of the pilot signal collision from the other device.

The following describes Manner 1 and Manner 2 above in detail.

Manner 1: The receiving apparatus determines the related information of the pilot signal collision by itself.

For example, the receiving apparatus is a network device, and the network device has ability to determine the pilot signal collision.

For downlink transmission, the network device could generate a UE specific pilot pattern for every UE scheduled for transmission on a certain radio resource in downlink. Then the network device could determine all the pilot signal collisions happened based on these UE's specific pilot patterns on this radio resource.

For uplink transmission, in some condition, the pilot pattern for a UE in uplink transmission is scheduled and assigned by a network device. Therefore, the network device could determine pilot signal collision in uplink. The network device could generate a UE specific pilot pattern for every UE scheduled for transmission on a certain radio resource in uplink. Then the network device could determine all the pilot signal collisions based on these UE specific pilot patterns on this radio resource.

In some embodiments, the receiving apparatus (the network device) determines the related information of the pilot signal collision in any one of the following implementations.

In a possible implementation, the receiving apparatus could generate all pilot patterns of scheduled UEs on an allocated radio resource, then the receiving apparatus could identify all the pilot signal collisions by mapping the UE specific pilot patterns of all the scheduled UEs.

For example, the receiving apparatus generates all pilot patterns of scheduled UEs on the allocated radio resource, and map the UE specific pilot patterns of all the scheduled UEs, then the receiving apparatus could identify a location (for example, the first resource unit, or the second resource unit) where two or more of all the scheduled UEs configured to transmit the pilot signal on the same resource unit (for example, the same subcarrier (or RE) and the same OFDM symbol).

In another possible implementation, the receiving apparatus could generate pilot patterns of all the scheduled UEs on the allocated resource, and then the receiving apparatus could identify all the pilot signal collisions by comparing the pilot patterns of all the scheduled UEs.

For example, the receiving apparatus generates a pilot pattern of a scheduled UE (UE #1) on an allocated radio resource (resource #1), and then generates a pilot pattern of another scheduled UE (UE #2). The receiving apparatus could map the UE #2 specific pilot pattern on the resource #1 to identify a location (for example, the first resource unit, or the second resource unit) where the UE #2 and the UE #1 are configured to transmit the pilot signal on the same resource unit (for example, the same subcarrier (or RE) and the same OFDM symbol).

Manner 2: The receiving apparatus receives the related information of the pilot signal collision from the other device.

For example, the receiving apparatus is a UE, and the UE could receive the related information of the pilot signal collision from a network device. The network device determines the related information of the pilot signal collision, and reference may be made to the related descriptions in the foregoing embodiment. Details are not described again.

In some embodiments, the receiving apparatus performs channel estimation with the pilot signals received on the M resource unit(s) in any one of the following manners.

Manner #a: The receiving apparatus performs channel estimation with the pilot signals received on the M resource unit(s) based on indication information #1 (for example, the third information) from the other communication device.

Manner #b: The receiving apparatus performs channel estimation with the pilot signals received on the M resource unit(s) by itself.

The following describes Manner #a and Manner #b above in detail.

Manner #a: The receiving apparatus performs channel estimation with the pilot signals received on the M resource unit(s) based on the indication information #1.

In some embodiments, the method 500 further includes step 540.

S540, the receiving apparatus transmits or receives the indication information #1 indicating the resource units #1. For example, the indication information #1 indicates that pilot signal collision happened on the resource units #1, or, the indication information #1 indicates that the pilot signal is not transmitted on the resource units #1.

In some embodiments, the step S520 specifically includes: the receiving apparatus receives the pilot signals on the M resource unit(s) based on the configuration information of the pilot signal and the indication information #1.

For example, the receiving apparatus is a network device, and the transmitting apparatus is a UE.

In this example, the network device transmits the indication information #1 to the UE, the UE transmits pilot signals (that is uplink pilot signals, e.g. SRS) on the resource units other than the resource unit #1 among the N resource units, that is to say, the UE transmits pilot signals on the M resource unit(s). The network device receives the pilot signals on the M resource unit(s) from the UE, and the network device performs channel estimation with the pilot signals received on M resource unit(s).

For another example, the receiving apparatus is a UE, the receiving apparatus is a network device, and the transmitting apparatus is a network device.

In this example, the UE receives the indication information #1 from the network device. According to the indication information #1, the UE receives pilot signals (that is downlink pilot signals, e.g. CSI-RS) on the resource units other than the resource unit #1 among the N resource units, that is to say, the UE receives pilot signals on the M resource unit(s). The UE performs channel estimation with the pilot signals received on M resource unit(s).

The resource unit #1 is used to represent the location of the pilot signal collision. The resource unit #1 is a resource other than the M resource unit(s) among the N resource units.

The indication information #1 is to inform related devices of the null signal transmitted on the location of the pilot signal collision. For example, the indication information #1 could include the information regarding the location of the pilot signal collision where no signal will be transmitted. In some embodiments, the indication information #1 includes one or more of: number of locations of pilot signal collision, location information of pilot signal collision, and indication of no signal transmitted on the resource unit #1.

The above description does not limit downlink transmission and uplink transmission, and the following is described in combination with the downlink transmission and uplink transmission.

The receiving apparatus may perform channel estimation with the pilot signals received on the M resource unit(s) based on indication information #1 in the following cases: downlink transmission and uplink transmission.

Manner #a is described below in combination with above cases.

Case 1: Downlink transmission.

In this case, when the network device needs to transmit pilot signals to different UEs, the pilot signal collision may happen. For example, in this case, the receiving apparatus is a UE.

By using Manner #a, the network device could inform collision UEs of the locations of the pilot signal collision explicitly. The collision UEs are UEs scheduled to receive pilot signals on the locations of the pilot signal collision. Specifically, the network device could determine the locations of pilot signal collision, and the network device could make decision on where (on which locations of pilot signal collision) not to transmit any signal. Then the network device could transmit the indication information #1 to collision UEs to inform that null signal transmitted on the location of the pilot signal collision. This indication information #1 could include the information regarding the location of the pilot signal collision where no signal will be transmitted, which may include but be not limited to number of locations of pilot signal collision, location information of pilot signal collision (e.g. a RB index and/or an OFDM symbol index), indication of no signal transmitted, etc. UE could receive and interpret this indication information #1, and then perform pilot signal processing and channel estimation as defined in its own system.

In a possible implementation, the network device could broadcast, multicast or unicast this indication information #1 in downlink. When this indication information #1 is transmitted in a unicast mode, which only gives to one specific UE, the information regarding the locations of pilot signal collision could be the pilot signal collisions related to this specific UE. When this indication information #1 is transmitted in a multicast or broadcast mode, which targets a group of UEs, the information of locations of pilot signal collision could be all the pilot signal collisions involved in this group of UEs, and the information of locations of pilot signal collision could be listed UE by UE.

For the network device, pilot signal is not transmitted by the network device on a location of the pilot signal collision, and the network device could transmit the information about the location of pilot signal collision where no signal transmitted to the collision UEs.

Correspondingly, for the UE, the UE could receive and interpret this indication information #1, then the UE could take operation as defined in its own system. From this indication information #1, the UE could know which pilot location in its own pilot pattern is the location of the pilot signal collision happened and where there is no pilot signal transmitted. In some condition, the UE could remove the location of the pilot signal collision from its own pilot pattern (this means to stop measuring the pilot signal on all the related antenna ports received on the location of the pilot signal collision), and then perform channel estimation without determining pilot signal on that location.

Case2: Uplink transmission.

In this case, when pilot signals are sent from different UEs to a network device, the pilot signal collision may happen. For example, in this case, the receiving apparatus is a network device.

By using Manner #a, the network device could determine the locations of pilot signal collision and inform collision UEs the locations of pilot signal collision where the network device wants the UE to avoid transmitting the pilot signal by downlink signaling (the indication information). UE could receive and interpret this signaling, and avoid transmitting the pilot signal on the indicated location of pilot signal collision accordingly.

In a possible implementation, the network device could request all the collision UEs on the location of pilot signal collision not to transmit the pilot signal on the location of pilot signal collision. For example, the network device could transmit the indication information to all the collision UEs on the location of pilot signal collision not to transmit the pilot signal on the location of pilot signal collision. This indication information could include the information regarding the locations of pilot signal collision, which may include but be not limited to number of locations of pilot signal collision, location information of pilot signal collision (e.g. a RB index and/or an OFDM symbol index), an expected handling method for UE (e.g. no signal transmitted on the location of pilot signal collision), etc. The network device could broadcast, multicast or unicast this indication information. When this indication information is transmitted in a unicast mode, that is, this indication information is transmitted to one specific UE, this indication information regarding the locations of pilot signal collision could be the pilot signal collisions related to this specific UE. When this indication information is transmitted in a multicast or broadcast mode, which targets a group of UEs, the information of locations of pilot signal collision could be all the pilot signal collisions happened on this group of UEs, or the information of location of pilot signal collision could be listed UE by UE.

In another possible implementation, the network device could select one UE to remain transmitting the pilot signal on the location of the pilot signal collision and request all the other collision UEs to not to transmit the pilot signal on the location of pilot signal collision. The network device doesn't need to transmit this indication information to the UE selected to transmit the pilot signal on the location of the pilot signal collision, but needs to transmit this indication information to inform all the other collision UEs who have been requested to stop transmitting the pilot signal on the location of the pilot signal collision. This indication information is described in detail on above, and for brevity, details are not described herein again. When this indication information is transmitted in a unicast mode, that is, this indication information is transmitted to one specific UE, the information regarding the locations of pilot signal collision could be the pilot signal collisions related to this specific UE. When this indication information is transmitted in a multicast or broadcast mode, which targets a group of UEs, the information of locations of pilot signal collision could be all the pilot signal collisions happened on this group of UEs, or the information of location of pilot signal collision could be listed UE by UE.

For the network device, the network device could have the knowledge of what pilot pattern each UE uses in transmitting a pilot signal. Once the network device transmits this indication information to request some UEs to stop transmitting pilot signals on some locations of pilot signal collision, the network device could update its receiving pilot pattern for collision UEs accordingly, for example, the network device may remove locations of pilot signal collision where no pilot signal be transmitted from collision UEs. For a UE who has been requested to stop transmitting pilot signals on locations of pilot signal collision, the network device could perform channel estimation of that UE with the updated receiving pilot pattern for that UE, which not include the pilot signal on locations of pilot signal collision.

Correspondingly, for the UE, the UE could receive and interpret this indication information, and stop to transmit the pilot signal on the location of the pilot signal collision as indicated by the network device.

Manner #b: The receiving apparatus performs channel estimation with the pilot signals received on the M resource unit(s) by itself. By using such method, the receiving apparatus could have the ability to identify the locations where the pilot signal is not transmitted when pilot signal collision happens.

In a possible implementation, the receiving apparatus determines the pilot signals on the M resource unit(s) for channel estimation based on a receiving power of the pilot signal and a threshold range, where the receiving power of the pilot signal on the M resource unit(s) is within the threshold range, and the receiving power of the pilot signals on locations other than the M resource unit(s) among the N resource units is outside the threshold range.

The threshold range may be indicated by the network device, or by the UE, or may be predefined, for example, defined in a protocol. This is not limited in this application.

Specifically, the receiving apparatus could detect and measure the pilot signal power received on all locations (namely, N resource units), and according to the pilot signal power and the threshold range, the receiving apparatus could determine which pilot signal to use for channel estimation. For example, if the pilot signal power is outside the threshold range, the receiving apparatus could determine that this pilot location has no pilot signal transmitted or pilot signal collision has happened. Namely, the receiving apparatus could discard the pilot signal received on all the antenna ports on this location and perform channel estimation without considering pilot signal transmitted on this location. If the pilot signal power is within the threshold range, the receiving apparatus could use the pilot signal for channel estimation.

If the receiving apparatus has multiple antenna ports, the receiving apparatus could determine an indication value (referred to “indication signal power” in the following description) to represent the received signal level measured on a transmitted pilot signal. Specifically, if the receiving apparatus has multiple antenna ports, the antenna ports as defined in the receiving apparatus's pilot pattern could be used to receive the pilot signal and each antenna port could generate a measured pilot signal power value. Therefore, multiple antenna ports could generate multiple measured pilot signal power values from the same transmitted pilot signal. We could apply some algorithms on these multiple measured pilot signal power values generated from one transmitted pilot signal and determine an indication signal power to represent the received signal level measured on a transmitted pilot signal. For example, this indication signal power could be got by averaging these multiple measured pilot signal power values.

In a possible implementation, the threshold range is a threshold, the receiving apparatus determines the pilot signals on the M resource unit(s) for channel estimation based on a receiving power of the pilot signal and the threshold. For example, if the indication signal power is lower than the threshold, the receiving apparatus could determine that this pilot location has no pilot signal transmitted, and perform channel estimation without considering pilot signal transmitted on this location. For another example, if the indication signal power is higher than the threshold, the pilot signal of this pilot location could be treated as being mistaken by the receiving apparatus, or the receiving apparatus could determine that a pilot signal collision has happened at this pilot location, and the receiving apparatus could perform channel estimation without considering pilot signal transmitted on this location.

In another possible implementation, the threshold range are two thresholds, the receiving apparatus determines the pilot signals on the M resource unit(s) for channel estimation based on a receiving power of the pilot signal and the two thresholds, a high threshold and a low threshold. For example, if the indication signal power is lower than the low threshold or higher than the high threshold, the receiving apparatus could determine this pilot location has no pilot signal transmitted or pilot signal collision has happened, and perform channel estimation without considering pilot signal transmitted on this location.

The above description does not limit downlink transmission and uplink transmission, and the following is described in combination with the downlink transmission and uplink transmission.

The receiving apparatus performs channel estimation with the pilot signals received on the M resource unit(s) by itself may be performed in the following cases: downlink transmission and uplink transmission.

Manner #b is described below in combination with above cases.

Case 1: Downlink transmission.

In this case, when the network device needs to transmit pilot signals to different UEs, the pilot signal collision may happen. For example, in this case, the receiving apparatus is a UE.

By using Manner #b, the network device could determine the locations of pilot signal collision, and the network device could make decision on where (on which locations of pilot signal collision) to not transmit any signal. Then the network device could do nothing special including informing UEs of the locations of pilot signal collision by signaling. Once UE receives pilot signal, the UE could perform pilot signal processing and channel estimation as defined in its own system.

For the UE, the UE could define some mechanisms to operate on the received and measured pilot signals. The UE could detect and measure the pilot signal power received on all pilot locations.

In a possible implementation, the UE determines the pilot signals on the M resource unit(s) for channel estimation based on a receiving power of the pilot signal and a threshold. For example, if the indication signal power is lower than the threshold, the UE could determine that this pilot location has no pilot signal transmitted, and perform channel estimation without considering pilot signal transmitted on this location. For another example, if the indication signal power is higher than the threshold, the pilot signal of this pilot location could be treated as being mistaken by the UE, or the UE could determine that a pilot signal collision has happened at this pilot location, and the UE could perform channel estimation without considering pilot signal transmitted on this location. The UE could discard the pilot signal measured on all the antenna ports on this location and perform channel estimation without considering the pilot signal transmitted on this location.

In another possible implementation, the UE determines the pilot signals on the M resource unit(s) for channel estimation based on a receiving power of the pilot signal and two thresholds, the high threshold and the low threshold. For example, if the indication signal power is higher than the high threshold or lower than the low threshold, the UE could determine this transmitted pilot signal has been interfered or has a problem. The UE could discard the pilot signal measured on all the antenna ports on this location and perform channel estimation without considering the pilot signal transmitted on this location.

By using this method, the network device could choose to do nothing related to locations of pilot signal collision in downlink signaling. In some condition, the network device could not determine locations of pilot signal collision. In some condition, the network device could determine the locations of pilot signal collision but make decision to not inform collision UEs.

Case2: Uplink transmission.

In this case, when pilot signals are sent from different UEs to a network device, the pilot signal collision may happen. For example, in this case, the receiving apparatus is a network device.

In this case, by using Manner #b, each UE could transmit pilot signals as defined in a UE's pilot pattern. The network device receives a pilot signal, and the network device could perform pilot signal processing and channel estimation as defined in the system. The network device could choose to do nothing related to locations of pilot signal collision in downlink signaling.

By using the Manner #b, the network device could not need to determine locations of pilot signal collision and the network device has no pre-knowledge of locations of pilot signal collision. The network device could define some mechanisms to operate on the received and measured pilot signals.

For example, there are two thresholds, a high threshold and a low threshold. If the pilot signal power (or the indication signal power) is higher than the high threshold or lower than the low threshold, the network device could determine this pilot signal has been interfered or has a problem. The network device could discard the pilot signal received on all the antenna ports on this location and perform channel estimation without considering the pilot signal transmitted on this location.

For another example, there is one threshold, a low threshold. If the pilot signal power (or the indication signal power) is lower than the low threshold, the network device could determine this pilot location has no pilot signal transmitted. The network device could discard the pilot signal measured on all the antenna ports on this location and perform channel estimation without considering pilot signal transmitted on this location.

A manner in which the receiving apparatus determines to perform channel estimation with the pilot signals received on the M resource unit(s) by itself is not limited in this application. For example, the receiving apparatus could determine locations of pilot signal collision and the receiving apparatus has pre-knowledge of locations of pilot signal collision. The receiving apparatus knows where to expect the multiple pilot signals received on the same pilot location. The receiving apparatus could discard the pilot signal measured on all the antenna ports on this location and perform channel estimation without considering pilot signal transmitted on this location.

Method 500 and method 300 are described separately, the above method 500 and method 300 may be used alone or in combination. For example, pilot signal collision of the different communication devices happens on the first resource unit and second resource unit (for example, the resource unit #1), the transmitting apparatus transmits the common pilot signal on the first resource unit, and the transmitting apparatus transmits pilot signals on the M resource unit(s), where the M resource unit(s) exclude the second resource unit. The second resource unit is different from the first resource unit, in other words, the first resource unit and the second resource unit are different locations of the pilot signal collision. Specifically, the different communication devices suffer from pilot signal collision on some locations, and the locations include the first resource unit and the second resource unit. For an example, a receiving apparatus #1 and a receiving apparatus #2 suffer from pilot signal collision on the first resource unit, and a receiving apparatus #3 and a receiving apparatus #4 suffer from pilot signal collision on the second resource unit. For another example, the receiving apparatus #1 and the receiving apparatus #2 suffer from pilot signal collision on the first resource unit, and the receiving apparatus #1 and the receiving apparatus #4 suffer from pilot signal collision on the second resource unit. For another example, the receiving apparatus #1 and the receiving apparatus #2 suffer from pilot signal collision on the first resource unit and the second resource unit.

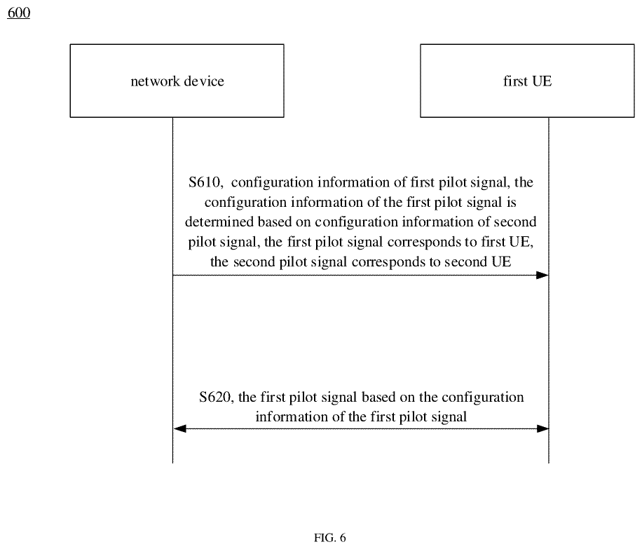

Referring to FIG. 6, FIG. 6 is a schematic flowchart of a communication method 600 according to an embodiment of this application. The method 600 may be applied to the communication system 100 shown in FIG. 1(a).

S610, a network device transmits configuration information of first pilot signal, the configuration information of the first pilot signal is determined based on configuration information of second pilot signal, the first pilot signal corresponds to first UE, the second pilot signal corresponds to second UE.

Correspondingly, the first UE receives the configuration information of the first pilot signal.

The first UE transmits or receives the first pilot signal, therefore, the first pilot signal corresponds to the first UE. The second UE transmits or receives the second pilot signal, that is, the second pilot signal corresponds to the second UE.

S620, the network device transmits or receives the first pilot signal based on the configuration information of the first pilot signal.

For an example, the first pilot signal is uplink pilot signal (e.g. SRS), where S620 includes: the network device receives the first pilot signal. Correspondingly, the first UE transmits the first pilot signal based on the configuration information of the first pilot signal.

In a possible implementation, the configuration information of the first pilot signal includes the resource allocation options of the first pilot signal, in this implementation, the first UE transmits the first pilot signal based on the configuration information of the first pilot signal includes: the first UE transmits the first pilot signal by using the resource allocation options indicated by the configuration information.

In another possible implementation, the configuration information of the first pilot signal includes the pilot pattern of the first pilot signal, in this implementation, the first UE transmits the first pilot signal based on the configuration information of the first pilot signal includes: the first UE transmits the first pilot signal, where the pilot pattern of the first pilot signal is determined based on the configuration information.

For another example, the first pilot signal is downlink pilot signal (e.g. CSI-RS), where S620 includes: the network device transmits the first pilot signal. Correspondingly, the first UE receives the first pilot signal based on the configuration information of the first pilot signal.

In a possible implementation, the configuration information of the first pilot signal includes the resource allocation options of the first pilot signal, in this implementation, the first UE receives the first pilot signal based on the configuration information of the first pilot signal includes: the first UE receives the first pilot signal by using the resource allocation options indicated by the configuration information.

In another possible implementation, the configuration information of the first pilot signal includes the pilot pattern of the first pilot signal, in this implementation, the first UE receives the first pilot signal based on the configuration information of the first pilot signal includes: the first UE receives the first pilot signal, where the pilot pattern of the first pilot signal is determined based on the configuration information.

In some embodiments, the configuration information of the first pilot signal includes a resource allocation options of the first pilot signal, and/or, pilot pattern of the first pilot signal.

In a possible implementation, the resource allocation options of the first pilot signal includes one or more of: resource allocation, RB allocation, and TTI allocation.

There are two examples.

Example 1: The configuration information of the first pilot signal includes the resource allocation options of the first pilot signal.

In some condition, there may exist many UEs waiting to be scheduled at a same network device. The network device may generate a scheduling algorithm to avoid the transmission conflicts and/or transmission interference among these UEs. In 5G NR or other traditional system structure, the resource allocation options (e.g., resource allocation, RB allocation, TTI allocation and etc.) is performed by considering many factors such as buffer status report, QoS requirement, scheduling request and etc. The scheduling algorithm may be a process of balancing various factors. The network device could determine a resource allocation options to schedule these UEs which could result in no pilot signal collision or less locations of pilot signal collision. This could avoid or mitigate pilot signal collision. In this example, the network device schedules a first UE and a second UE. The network device could determine the resource allocation options of the first pilot signal based on a resource allocation options of the second pilot signal. Specifically, the resource allocation options of the first pilot signal and the resource allocation options of the second pilot signal are not overlap.

Assume the network device generates a resource allocation #2 (that is the resource allocation options of the second pilot signal) for the second UE. In a possible implementation, when the network device generates a resource allocation #1 (that is the resource allocation options of the first pilot signal) for the first UE, it can be made the resource allocation #1 does not overlap with the resource allocation #2, for example, RBs and TTIs of the resource allocation #1 does not overlap with RBs and TIIs of the resource allocation #2. In another possible implementation, the network device could generate W resource allocation options based on scheduling factors such as buffer status report, QoS requirement, scheduling request, etc. Where W>1. And the network device could determine the resource allocation #1 from the W resource allocation options by comparing the W resource allocation options and the resource allocation #2. The resource allocation #1 determined by the network device are not overlap with the resource allocation #2.

Example 2: The configuration information of the first pilot signal includes the pilot pattern of the first pilot signal.

The network device could determine some parameters (e.g., a random seed) related to a pilot pattern generation procedure of a UE. This means the network device could influence the generation of a pilot pattern of a UE by selecting different parameters. In the case of multiple UEs being scheduled simultaneously, the network device could determine the parameters to ensure that the pilot patterns generated for different UEs will have less locations of pilot signal collision or even no pilot signal collision. The network device could define parameters for pilot pattern generation for a single UE. The network device could also define parameters for pilot pattern generation for some UEs. The parameters could be communicated to UEs in downlink by using broadcast, multicast or unicast signaling. This signaling could contain the parameters defined by the network device for pilot pattern generation for a UE or for a group of UEs. In this example, the network device schedules a first UE and a second UE. The network device could determine the pilot pattern of the first pilot signal based on a pilot pattern of the second pilot signal.

In a possible implementation, the network device determines the pilot pattern of the second pilot signal, and determines one or more pilot patterns based on different parameters. The network device could map the one or more pilot patterns and the pilot pattern of the second pilot signal, then the network device determines the pilot pattern of the first pilot signal from the one or more pilot patterns, to ensure that the pilot pattern of the first pilot signal and the pilot pattern of the second pilot signal have less locations of pilot signal collision or even no pilot signal collision.

In some embodiments, the method 600 includes: the network device transmits the configuration information of the second pilot signal. Correspondingly, the second UE receives the configuration information of the second pilot signal. The configuration information of the second pilot signal could refer to the configuration information of the first pilot signal, for brevity, details are not described herein again.

The method 600 may be performed in the following cases: downlink transmission and uplink transmission. In the downlink transmission, the network device could generate a UE specific pilot pattern for every UE scheduled for transmission on a certain radio resource in downlink. In the uplink transmission, the network device could generate a UE specific pilot pattern for every UE scheduled for transmission on a certain radio resource in uplink.

Method 300, method 500 and method 600 are described separately, the above method 300, method 500, method 600 may be used alone or in combination.

There are some further examples to illustrate designs of solving pilot signal collision problem by using the above methods.

Referring to FIG. 4, FIG. 4 is a schematic diagram of illustration for solving pilot signal collision in downlink. As shown in FIG. 4, for example, a certain radio resource includes 24 subcarriers with subcarrier index 1 to 24 over 1 OFDM symbol with time symbol index n. After scheduling, a network device could transmit pilot signals on subcarrier index 1, 4, 12 and 21 of OFDM symbol n to UE1. The network device also could transmit pilot signals on subcarrier index 3, 7, 12 and 22 of OFDM symbol n to UE2. The network device detects the pilot signal collision. Since both pilot location to UE1 and pilot location to UE2 are scheduled to transmit a pilot signal on subcarrier index 12, and pilot signal collision is going to happen on subcarrier 12 on OFDM symbol index n.

By using the Manner #A of the method 300, the pilot value and the antenna port assigned to transmit pilot signal on each pilot location are defined based on some configured parameters. In this example, the pilot value and the antenna port assigned to transmit pilot is assumed to be based on subcarrier index. As shown in the left part of FIG. 4, different fills represent different pilot values for a pilot signal on a location. Assume 4 different pilot values in the system, the number on each subcarrier is the antenna port index assigned to transmit the pilot signal. For example, if there is a pilot signal be transmitted on subcarrier index 1, the network device is going to use antenna port index 1 to transmit pilot value 1 on this location. If there is a pilot signal to be transmitted on subcarrier index 18, the network device is going to use antenna port index 6 to transmit pilot value 2 on this location.

In this example, on each location of this radio resource, there is pre-defined pilot value and antenna port index assigned to transmit pilot determined based on a subcarrier index. For the location of the pilot signal collision (subcarrier index 12), a common pilot signal (pilot value 4) and an antenna port index assigned to transmit the common pilot signal (antenna port index 6) will be used. After considering the other pilots to UE1 and UE2, the final pilot signal scheme is shown in the right part of FIG. 4. On the UE side, both UE1 and UE2 will receive pilot signals as expected in its pilot pattern.

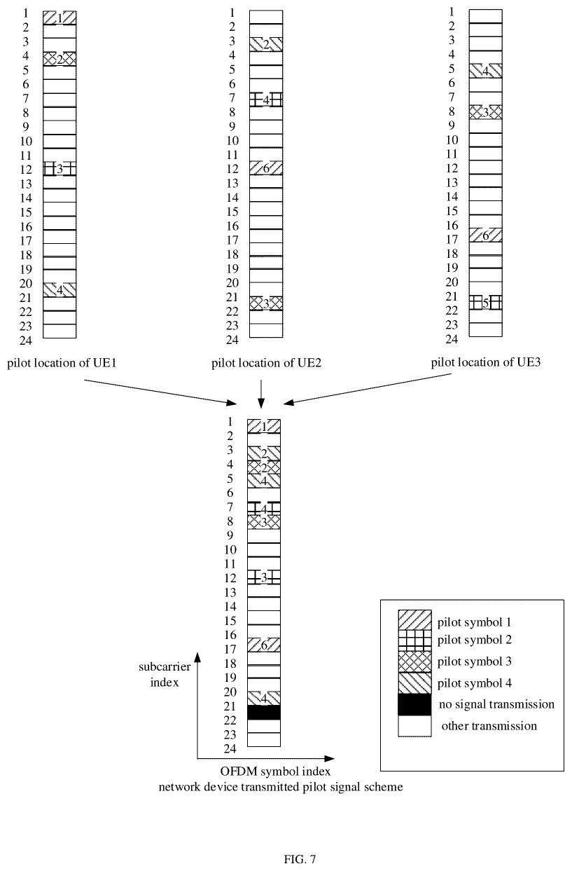

Referring to FIG. 7, FIG. 7 is another schematic diagram of illustration for solving pilot signal collision in downlink. As shown in FIG. 7, for example, a certain radio resource includes 24 subcarriers with subcarrier index 1 to 24 over 1 OFDM symbol with time symbol index n. After scheduling, a network device could transmit pilot signals on subcarrier index 1, 4, 12 and 21 of OFDM symbol n to UE1. The network device could transmit the pilot signal on subcarrier index 3, 7, 12 and 22 of OFDM symbol n to UE2. The network device also could transmit the pilot signal on subcarrier index 5, 8, 17 and 22 of OFDM symbol n to UE3. Pilot pattern of UE1, UE2 and UE3 is shown in the upper part of FIG. 7. Different fills represent different pilot values used in the pilot transmission. The number on a subcarrier box is an antenna port index assigned to transmit the pilot signal.

The network device detects the pilot signal collision. Since both pilot location to UE1 and pilot location to UE2 are scheduled to transmit a pilot signal on subcarrier index 12, pilot signal collision is going to happen on subcarrier 12 on OFDM symbol index n. Since both pilot location to UE2 and pilot location to UE3 are scheduled to transmit a pilot signal on subcarrier index 22, pilot signal collision is going to happen on subcarrier 22 on OFDM symbol index n.

After analyzing condition of pilot signal collision, the network device could use a pilot value (pilot value 2) and an antenna port index assigned to transmit the pilot signal (antenna port index 3) on subcarrier index 12 of UE1 to solve pilot signal collision happened on subcarrier index 12. And the network device could inform UE2 of location of pilot signal collision (subcarrier index 12), pilot value (pilot value 2) and antenna port index assigned to transmit pilot signal (antenna port index 3) by using downlink signaling. This operation is defined in Manner #B of the method 300.

The network device also could avoid transmitting any signal on subcarrier index 22 to solve pilot signal collision happened on subcarrier index 22. And the network device informs UE2 of location of pilot signal collision (subcarrier index 22) and no signal transmitted on that location by using downlink signaling as defined in Manner #a of the method 500. Regarding UE3, the network device could not transmit any information to UE3 and UE3 operates channel estimation as defined in its own system as in Manner #b of the method 500.

In this example, the network device could inform UE2 of information on two locations of pilot signal collision. This information could be unicast information transmitted to UE2. This information could be multicast or broadcast in downlink with UE2 as a receiving apparatus. For example, this information could indicate 2 pilot signal collisions: 1^{st} pilot signal collision on subcarrier index 12, pilot value 2 transmitted by antenna port index 3; 2^{nd} pilot signal collision on subcarrier index 22, and no signal transmitted. The network device could combine this information with other signaling. And information on two locations of pilot signal collision could be separated in two different messages in downlink signaling.

After resolving the pilot signal collision on subcarrier 12 and subcarrier 22, and considering the other pilot signals in pilot locations to UE1, UE2 and UE3, the final pilot signal scheme is shown in the lower part of FIG. 7. On the UE side, UE1 could receive all the 4 pilot signals as expected in its pilot pattern. UE2 could receive 2 pilot signals transmitted on subcarrier index 3 and 7 normally as expected, and could receive 1 pilot signal transmitted on subcarrier index 12 with pilot value 2 transmitted from antenna port index 3. UE2 could perform channel estimation by considering these 3 transmitted pilot signals or only considering pilot signals transmitted on subcarrier index 3 and 7. UE3 could expect to receive pilot signals on all subcarriers as defined in pilot pattern. UE3 could measure indication signal power on all the locations. Then UE3 could apply the predefined thresholds to determine which pilot signals to consider in doing channel estimation.

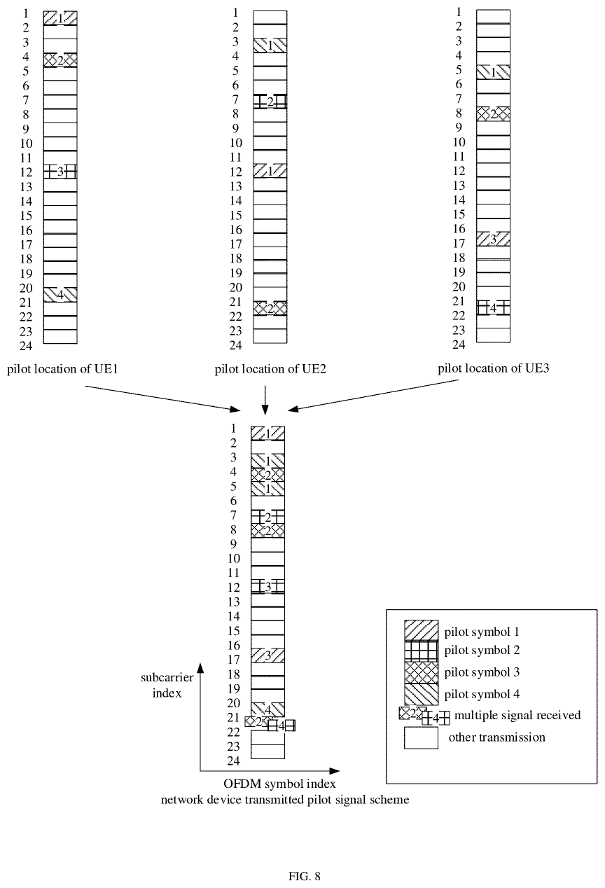

Referring to FIG. 8, FIG. 8 is a schematic diagram of illustration for solving pilot signal collision in uplink. As shown in FIG. 8, a certain radio resource is 24 subcarriers with subcarrier index 1 to 24 over 1 OFDM symbol with time symbol index n. After scheduling, A network device schedules UE1, UE2 and UE3 to transmit a pilot signal on this radio resource. The network device also knows the pilot signals from UE1 is expected on subcarrier index 1, 4, 12 and 21 of OFDM symbol n. Pilot signals from UE2 is expected on subcarrier index 3, 7, 12 and 22 of OFDM symbol n. Pilot signals from UE3 is expected on subcarrier index 5, 8, 17 and 22 of OFDM symbol n. Pilot location from UE1, UE2 and UE3 is shown in the upper part of FIG. 8. Different fills represent different pilot values used in the pilot signal transmission. The number on a subcarrier box is an antenna port index assigned to transmit the pilot signal.

The network device could use its ability to determine all the pilot signal collision. Since both pilot location from UE1 and pilot location from UE2 are scheduled to transmit a pilot signal on subcarrier index 12, pilot signal collision is going to happen on subcarrier 12 on OFDM symbol index n. Since both pilot location from UE2 and pilot location from UE3 are scheduled to transmit a pilot signal on subcarrier index 22, pilot signal collision is going to happen on subcarrier 22 on OFDM symbol index n.

After analyzing condition of pilot signal collision, the network device could allow UE1 to transmit the pilot signal on subcarrier 12 and stop UE2 to transmit its pilot signal on the same subcarrier. And the network device could inform UE2 of the location of pilot signal collision (subcarrier index 12) and perform operation such as not to transmit the pilot signal by using downlink signaling. This operation is defined in Manner #a of the method 500.

The network device also detects pilot signal collision happened on subcarrier index 22. The network device could let UE2 and UE3 transmit their pilot signals as normal on this location. The network device could not transmit any information to UE2 and UE3 regarding pilot signal collision on subcarrier index 22 as defined in Manner #b of the method 500.

In this example, the network device needs to inform UE2 of information on one location of pilot signal collision. This information could be unicast information transmitted to UE2. This information could be multicast or broadcast in downlink with UE2 as a receiving apparatus. For example, this information could indicate UE2 to avoid transmitting pilot signal on subcarrier index 12. The network device could combine this information with other signaling.

After resolving the pilot signal collision on subcarrier 12 and subcarrier 22, considering the other pilot signals in pilot locations to UE1, UE2 and UE3, the final pilot signal scheme is shown in the lower part of FIG. 8. The network device expects to receive and measure four pilot signals from UE1 and could perform channel estimation by considering these four pilot signals. The network device expects to receive only two pilot signals normally from UE2 which are pilot signals transmitted on subcarrier index 3 and 7. The network device could do channel estimation for UE2 channel by considering these two pilot signals. The network device expects to receive three pilot signals normally from UE3 which are pilot signals transmitted on subcarrier index 5, 8 and 17. The network device could perform channel estimation for UE3 channel by considering these three pilot signals.

In some condition, the network device may separate overlapped signals on subcarrier index 22 with advanced signal processing algorithm when transmitted signal from different UEs. Then the network device could perform channel estimation for UE2 channel with pilot signal received on subcarrier index 3, 7 and 22. The network device could perform channel estimation for UE3 channel with all pilot signal transmitted.

To facilitate understanding of this application embodiment, in the exemplary description, an OFDM symbol index is used to represent a time domain unit. The OFDM symbol may be replaced with the other time domain unit. Similarly, a subcarrier index is used to represent a frequency domain unit and a port index is used to represent a spatial domain unit. A subcarrier may be replaced with the other frequency domain unit.

In the embodiments of this application, the pilot signal could be replaced with a reference signal.

In the embodiments of this application, “and/or” describes an association relationship between associated objects and represents that three relationships may exist. For example, A and/or B may represent the following three cases: Only A exists, both A and B exist, and only B exists. The character “/” generally indicates an “or” relationship between the associated objects. “At least one” means one or more. “At least one of A and B”, similar to “A and/or B”, describes an association relationship between associated objects and represents that three relationships may exist. For example, at least one of A and B may represent the following three cases: Only A exists, both A and B exist, and only B exists.

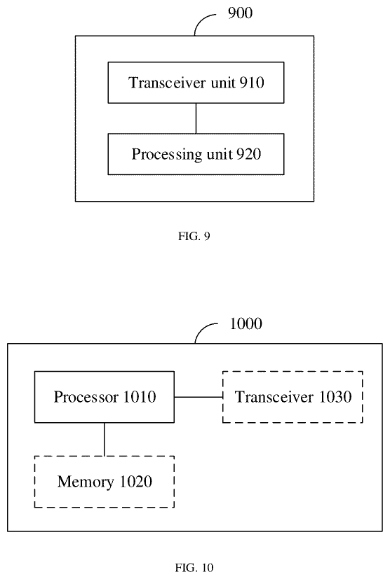

The methods according to embodiments of this application are described above in detail with reference to FIGS. 3-8. The apparatuses provided in embodiments of this application are described below in detail with reference to FIGS. 9-10. Description of apparatus embodiments corresponds to the description of the method embodiments. Therefore, for content that is not described in detail, refer to the foregoing method embodiments. For brevity, details are not described herein again.

The communication method according to the embodiments of this application is described in detail above with reference to FIGS. 3-8, and the transmitting apparatus and the receiving apparatus according to the embodiments of this application will be described in detail below with reference to FIGS. 9-10.

Referring to FIG. 9, FIG. 9 is a schematic block diagram of a communication apparatus according to an embodiment of this application. The communication apparatus 900 includes a transceiver unit 910 and a processing unit 920. The transceiver unit 910 may implement a corresponding communication function, and the processing unit 910 is configured to perform data processing. The transceiver unit 910 may also be referred to as a communication interface or a communication unit.

In some embodiments, the communication apparatus 900 may further include a storage unit. The storage unit may be configured to store instructions and/or data. The processing unit 920 may read the instructions and/or data in the storage unit, to enable the communication apparatus to implement the foregoing method embodiments.

The communication apparatus 900 may be configured to perform the actions performed by the transmitting apparatus in the foregoing method embodiments. In this case, the communication apparatus 900 may be the transmitting apparatus or a component that can be configured in the transmitting apparatus. The transceiver unit 910 is configured to perform receiving/transmitting-related operations on the transmitting apparatus side in the foregoing method embodiments. The processing unit 920 is configured to perform processing-related operations on the transmitting apparatus side in the foregoing method embodiments.

Or, the communication apparatus 900 may be configured to perform the actions performed by the receiving apparatus in the foregoing method embodiments. In this case, the communication apparatus 900 may be the receiving apparatus or a component that can be configured in the receiving apparatus. The transceiver unit 910 is configured to perform receiving/transmitting-related operations on the receiving apparatus side in the foregoing method embodiments. The processing unit 920 is configured to perform processing-related operations on the receiving apparatus side in the foregoing method embodiments.

In a design, the communication apparatus 900 is configured to perform actions performed by the transmitting apparatus in the foregoing method embodiments.

In an implementation, the transceiver unit 910 is configured to transmit first information indicating information of a common pilot signal, where the common pilot signal is being transmitted on a first resource unit, and pilot signal collision of different communication devices happens at least on the first resource unit; transmit the common pilot signal on the first resource unit.

The communication apparatus 900 may implement steps or procedures performed by the transmitting apparatus in FIG. 3 according to embodiments of this application. The communication apparatus 900 may include units configured to perform the methods performed by the transmitting apparatus in FIG. 3. In addition, the units in the communication apparatus 900 and the foregoing other operations and/or functions are separately used to implement corresponding procedures in FIG. 3.

In another implementation, the processing unit 920 is configured to determine configuration information of a pilot signal indicating that the pilot signal is transmitted on N resource units, N>1; the transceiver unit 910 is configured to receives the pilot signal on the N resource units based on the configuration information of the pilot signal. The processing unit 920 is configured to perform channel estimation with the pilot signal received on the M resource unit(s).

The communication apparatus 900 may implement steps or procedures performed by the transmitting apparatus in FIG. 5 according to embodiments of this application. The communication apparatus 900 may include units configured to perform the methods performed by the co transmitting apparatus in FIG. 5. In addition, the units in the communication apparatus 900 and the foregoing other operations and/or functions are separately used to implement corresponding procedures in FIG. 5.

The communication apparatus 900 may implement steps or procedures performed by the network device in FIG. 6 according to embodiments of this application. The communication apparatus 900 may include units configured to perform the methods performed by the network device in FIG. 6. In addition, the units in the communication apparatus 900 and the foregoing other operations and/or functions are separately used to implement corresponding procedures in FIG. 6.

In another design, the communication apparatus 900 is configured to perform actions performed by the receiving apparatus in the foregoing method embodiments.

In an implementation, the transceiver unit 910 is configured to receive first information indicating information of a common pilot signal, the common pilot signal is being transmitted on a first resource unit, where pilot signal collision of different communication devices happens at least on the first resource unit; receive the common pilot signal on the first resource unit.

The communication apparatus 900 may implement steps or procedures performed by the receiving apparatus in FIG. 3 according to embodiments of this application. The communication apparatus 900 may include units configured to perform the methods performed by the receiving apparatus in FIG. 3. In addition, the units in the communication apparatus 900 and the foregoing other operations and/or functions are separately used to implement corresponding procedures in FIG. 3.

The communication apparatus 900 may implement steps or procedures performed by the receiving apparatus in FIG. 5 according to embodiments of this application. The communication apparatus 900 may include units configured to perform the methods performed by the receiving apparatus in FIG. 5. In addition, the units in the communication apparatus 900 and the foregoing other operations and/or functions are separately used to implement corresponding procedures in FIG. 5.

The communication apparatus 900 may implement steps or procedures performed by the UE in FIG. 6 according to embodiments of this application. The communication apparatus 900 may include units configured to perform the methods performed by the UE in FIG. 6. In addition, the units in the communication apparatus 900 and the foregoing other operations and/or functions are separately used to implement corresponding procedures in FIG. 6.

A specific process in which the units perform the foregoing corresponding steps is described in detail in the foregoing method embodiments. For brevity, details are not described herein again.

Referring to FIG. 10, FIG. 10 is a schematic block diagram of another communication apparatus according to an embodiment of this application. The communication apparatus 1000 includes a processor 1010. The processor 1010 is coupled to a memory 1020. The memory 1020 is configured to store a computer program or instructions and/or data. The processor 1010 is configured to execute the computer program or instructions and/or data stored in the memory 1020, so that the methods in the foregoing method embodiments are executed.

In some embodiments, the communication apparatus 1000 includes one or more processors 1010.

In an example, as shown in FIG. 10, the communication apparatus 1000 may further include the memory 1020.

In some embodiments, the communication apparatus 1000 may include one or more memories 1020.

In an example, the memory 1020 may be integrated with the processor 1010, or disposed separately from the processor 1010.

In an example, as shown in FIG. 10, the communication apparatus 1000 may further include a transceiver 1030, and the transceiver 1030 is configured to receive and/or transmit a signal. For example, the processor 1010 is configured to control the transceiver 1030 to receive and/or transmit a signal.

In a solution, the communication apparatus 1000 is configured to perform the operations performed by the transmitting apparatus in the foregoing method embodiments.

For example, the processor 1010 is configured to perform a processing-related operation performed by the transmitting apparatus in the foregoing method embodiments, and the transceiver 1030 is configured to perform a receiving/transmitting-related operation performed by the transmitting apparatus in the foregoing method embodiments.

In another solution, the communication apparatus 1000 is configured to perform the operations performed by the receiving apparatus in the foregoing method embodiments.

For example, the processor 1010 is configured to perform a processing-related operation performed by the receiving apparatus in the foregoing method embodiments, and the transceiver 1030 is configured to perform a receiving/transmitting-related operation performed by the receiving apparatus in the foregoing method embodiments.

An embodiment of this application further provides a computer-readable storage medium. The computer-readable storage medium stores computer instructions used to implement the method performed by the transmitting apparatus or the method performed by the receiving apparatus in the foregoing method embodiments.

For example, when the computer program is executed by a computer, the computer is enabled to implement the method performed by the transmitting apparatus or the method performed by the receiving apparatus in the foregoing method embodiments.

An embodiment of this application further provides a computer program product including instructions. When the instructions are executed by a computer, the computer is enabled to implement the method performed by the transmitting apparatus or the method performed by the receiving apparatus in the foregoing method embodiments.

An embodiment of this application further provides a communication system. The communication system includes the transmitting apparatus and the receiving apparatus in the foregoing embodiments.

For explanations and beneficial effects of related content of any communication apparatus provided above, refer to a corresponding method embodiment provided above. Details are not described herein again.

The processor mentioned in embodiments of this application may be a central processing unit (central processing unit, CPU), the processor may further be another general-purpose processor, a digital signal processor (digital signal processor, DSP), an application-specific integrated circuit (application specific integrated circuit, ASIC), a field programmable gate array (field programmable gate array, FPGA), or another programmable logic device, a discrete gate, a transistor logic device, a discrete hardware component, or the like. The general-purpose processor may be a microprocessor, or the processor may be any conventional processor or the like.

The memory mentioned in embodiments of this application may be a volatile memory or a non-volatile memory, or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM). For example, the RAM may be used as an external cache. By way of example but not limitation, the RAM may include a plurality of forms in the following: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

It should be noted that when the processor is a general-purpose processor, a DSP, an ASIC, an FPGA, another programmable logic device, a discrete gate or a transistor logic device, or a discrete hardware component, the memory (storage module) may be integrated into the processor.

It should be further noted that the memory described in this specification is intended to include, but is not limited to, these memories and any other memory of a suitable type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing apparatus and unit, refer to a corresponding process in the foregoing method embodiment. Details are not described herein again.

In the several embodiments provided in this application, the disclosed apparatuses and methods may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic forms, mechanical forms, or other forms.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

In addition, function units in embodiments of this application may be integrated into one unit, or each of the units may exist alone physically, or two or more units are integrated into one unit.

All or some of foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (solid state disk, SSD)), or the like. For example, the usable medium may include but is not limited to any medium that can store program code, such as a USB flash drive, a removable hard disk, a read-only memory (read-only memory, ROM), a random access memory (random access memory, RAM), a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

### A System and Method of Pilot Collision Handling

The present application relates to wireless communication in a wireless network.

Definitions of acronyms & glossaries

| | |
|---|---|
| NR | New Radio |
| gNB | Next generation base station |
| BS | Base station |
| UE | User equipment |
| MIMO | Multiple-Input Multiple-Output |
| T-MIMO | Terabit MIMO |
| QRD | QR decomposition |
| DL | downlink |
| UL | uplink |
| RE | resource element |
| RB | resource block |
| UE ID | user equipment identifier |
| PCI | physical cell ID |
| TTI | transmission time interval |
| OFDM | orthogonal frequency division multiplexing |

In a wireless communication system, it is important to acquire the characteristics of a channel. In order to estimate channel, pilot signals (reference signals) known to both transmitter and receiver are transmitted. The receiver can estimate the channel by measuring the pilot signals sent by the transmitter and comparing the measurements with the known transmitted signals.

In 5G NR system, the pilots are distributed densely enough along the frequency direction to keep up with the varying radio channel. In case of multiple antenna ports, these pilots must be distributed densely enough along the frequency direction for every single port. If we continued to apply 5G NR scheme into T-MIMO system, an increasing number of antenna ports of T-MIMO would linearly increase the total number of the pilots.

The very large number of antenna ports of T-MIMO would require huge amount of pilots, and pilots becomes a heavy overhead of the time-frequency radio resource, which should have been allocated to data transmission. Furthermore, even though 5G-NR's cyclic-shift-based multiplexing method could alleviate the overhead to some degree, the total tolerable number of the ports multiplexed on the same subcarrier can get easily saturated by the inherent multiplexing interferences.

In order to solve the problem of a large amount of time-frequency radio resources being occupied by pilots in T-MIMO systems by using traditional 5G-NR methods for pilot allocation, we propose a new design method based on QRD to generate a non-uniform and very sparse pilot pattern and achieve similar channel estimation performance. The sparse pilot pattern generated by QRD method, though optimal in theory, tends to have some irregular pilot places, making it inefficient and tedious to signal and schedule their patterns among apparatus (for example between gNB and UEs). Furthermore, in order to address the issue of difficulty of indication problem of pilots generated by QRD method, we propose some pseudo-random sparse pilot generation methods. In these new methods, the number of pilots proposed is more than that generated by QRD method, but far less than the number of pilots required by 5G-NR method. In the following description, we will refer to the methods of generating sparse pilot pattern such as QRD method, the new methods and other methods as sparse pilot pattern generation method.

By using sparse pilot pattern generation method, every device will be allocated with its own sparse pilot pattern. In some condition, it's hard to avoid collisions of pilots on some locations across devices, in which pilots for two or more different devices are by chance transmitted on the same time/frequency radio resource element.

This application disclosure is to solve collision issue due to sparse pilot pattern generated by sparse pilot pattern generation method for different users.

In some solutions, it is proposed that the number of pilots included in pilot pattern for a given UE may preferably be more than the theoretical minimum so that the system can tolerate a certain percentage of the missing pilots in the receiver side, if sparse pilot pattern is applied.

Therefore, if the number of the pilots in a collision is below the tolerable percentage (they could be treated as missed or mistaken pilots by the receiver), the receiver is still able to estimate or reconstruct the entire channel without significant performance loss.

In traditional design scheme, for example 5G-NR, the pilot is always allocated and indicated by the system to avoid collision problem from happening.

The traditional pilot design will avoid to allocate pilot signals from/to different users on the same location, therefore collision is not a problem. There is no prior art to solve the similar issue.

### Problem and Objective

Since T-MIMO requires a tremendous increase in the numbers of gNB (or BS) antenna ports and UE antenna ports, a significant portion of the time-frequency radio resource would be allocated to the pilots, if a similar 5G-NR method were to be adopted.

The use of sparse pilot pattern can ensure the accuracy of channel measurement and at the same time greatly reduce the amount of pilot usage. Moreover, if both parties of communication use the same method and parameters to generate pilot pattern, they can ensure that both parties generate the same pilot pattern without additional signaling overhead.

In some condition, the generated sparse pilot pattern is pseudo-random, which will cause the pilot patterns of two or more devices (ex. UEs) to overlap (collision) on certain locations. In this application, we will try to solve this pilot collision problem.

### Overview

In this application, we propose methods to solve the problem when two or more devices (ex. UE) allocated to transmit/receive pilot signals at the same frequency resource (ex. on the same RE) at the same time.

The current application can be used to solve the collision problem when two or more pilot signals allocated to transmit/receive on the same frequency resource at the same time. When a system adopted QRD methods or other methods to generate sparse pilot pattern, pilot collision may be happened and need to be handled.

In system design, when pilot patterns assigned to different devises exist collisions in some locations, we need some manners or procedures to deal with collision problem.

Products covered: telecommunication system where pilot collision may occur.

Manner for collecting infringement evidence: If the pilot pattern of a UE could be allocated independently without reference to the pilot pattern of other UEs, there needs to define collision handling procedures in the specification. If there is a possibility of collision among uplink pilots sending from different UEs, specific downlink signaling may be defined in specification to handle collision problem.

### EMBODIMENT

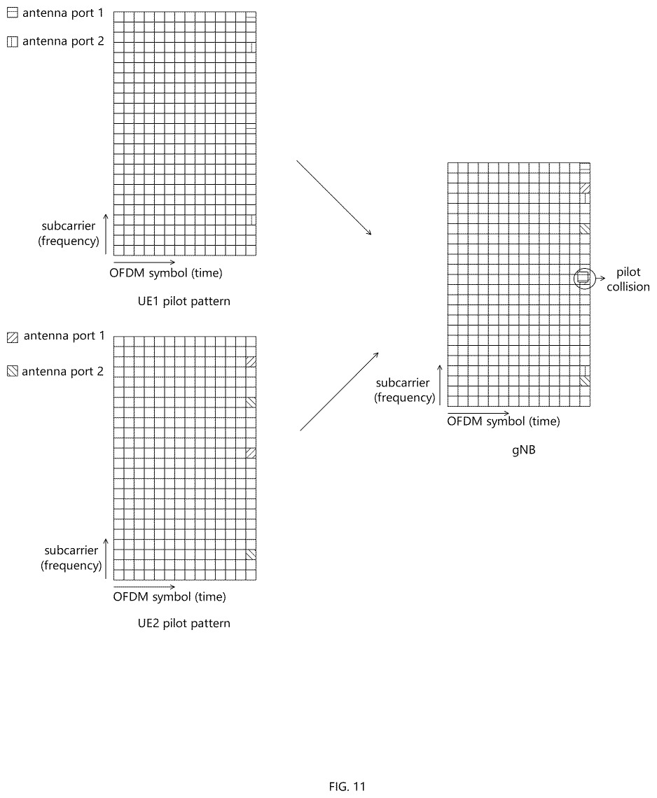

Some background issues
1. Sparse pilot pattern generated by using QRD method or other sparse pilot pattern generation methods will greatly reduce the number of pilot used and guarantee the channel estimation quality at the same time.
   When using pilots with sparse pilot pattern, the more pilot signals contribute to do channel estimation, the more accurate the estimated channel response to the real channel response, the better channel estimation quality. Sparse pilot pattern generation method will usually generate more pilots than required by ensuring the minimum channel estimation quality. Therefore, applying sparse pilot pattern generation method is not sensitive to pilot collision because it can tolerate a certain percentage of pilot missing (not send, not received or not measured) in the receiver side as far as the missing pilot is below a tolerable percentage. The receiver is still able to estimate or reconstruct the entire channel response without significant performance loss when some transmitted pilots are not considered in channel estimation procedure.
2. Pilot pattern definition
   Pilots are a series of reference signals which the locations and values are known to both transmitter and receiver. Pilots (pilot signals) are transmitted by one or more apparatus of transmitter device to one or more apparatus of receiver device, which are used to perform channel estimation. The process of channel estimation is to figure out the channel response (channel coefficients, channel status) or reconstruct channel.
   A pilot pattern is defined as a series of locations where the reference signals are transmitted to do channel estimation. A location is generally composed of indication information from three dimensions of time, frequency and spatial. But not all conditions require indication information in three dimensions to be specified. For example, dimension of frequency presents when OFDM is used. Dimension of spatial presents when MIMO is adopted in system. The location in frequency direction could be represented as subcarrier index, RE index and etc. The location in time direction could be represented as OFDM symbol index, time symbol index, TTI index and etc. The location in spatial direction could be represented as antenna port index in MIMO system.
3. In the following description, we are going to use gNB to represent apparatus such as eNB, BS and etc. in network side to provide connectivity between devices such as user equipment, UE, terminal and etc.; use UE to represent devices such as a smartphone, tablet, or other type of wireless device that is used to access to the network.
4. Pilot collision definition
   During the transmission, system may schedule different UEs to transmit on a certain radio resource, such as one time symbol (OFDM symbol), several RBs over several time symbols and etc. By using sparse pilot pattern method, there will be a pilot pattern (on which subcarrier index, antenna port index and/or time symbol index to transmit pilot signals) assigned for each scheduled UE as defined in specification. Unlike 5G-NR, the sparse pilot pattern assigned for different UE is calculated individually (UE may not refer to pilot pattern of other UEs when calculates its own pilot pattern). Once we put all the pilot patterns of different scheduled UEs together on the same radio resource scheme, we may find out that there may be more than one UE allocated to transmit/receive pilot signal on the same resource location, for example 2UEs allocated to transmit pilot signal on the same subcarrier (or RE) at the same OFDM symbol. The things happened on this resource location is called pilot collision.
   Pilot collision means different UEs plan to send pilot signal on the same resource location (ex. same subcarrier at the same time symbol). Pilot collision in downlink means pilot signals from two or more UEs are going to be put at the same subcarrier (or resource element) and at the same time symbol (ex. OFDM symbol). Pilot collision in uplink means pilot signals from two or more UEs are going to be transmitted at the same subcarrier (or resource element) and at the same time symbol (ex. OFDM symbol). We don't mention antenna port in pilot collision, since there will be only one antenna port active on one subcarrier at one OFDM symbol. Therefore, to identify pilot collision, we focus on the location defined by frequency and time.
   As illustrated in FIG. 11, the left up part shows UE1 specific pilot pattern and the left down part shows UE2 specific pilot pattern. When UE1 and UE2 are scheduled to transmit pilots at the same time, we may find that one pilot signal in UE1 pilot pattern overlaps with one pilot signal in UE2 pilot pattern. Pilot collision happens at that location where could be indicated by a certain subcarrier index (or RE index) and a certain OFDM symbol index (or TTJ index).
5. Pilot collision handling
   Unlike pilot assignment (allocation) method in 5G-NR and other traditional system, pilot collision is a new problem emerged with sparse pilot pattern design.
   In 5G-NR and other traditional system, the pilot signals for different UEs scheduled at the same resource block are calculated carefully to avoid collision or overlapping, and the pilot resource mapping information and other pilot related information are communicated with UEs by using signaling.
   In sparse pilot generation method, if parameters needed for pilot pattern generation are device specific ones and/or parameters which doesn't need to be communicated between gNB and UEs for the purpose of pilot generation, the gNB and UEs could generate the same pilot patterns without exchanging signaling.
   In 6G design, pilot collision is not very likely to happen due to the following reasons:
      Pilots are very sparse distributed, and bandwidth is very large, which means the ratio of number of allocated subcarriers to number of pilots is big.
      Pilot pattern is pseudo-random for different UE and every UE could generate its own specific pilot pattern.
      This procedure is like we have a very large number pool with different number appearing only once (compare to number of subcarriers is big), and each time we randomly draw a set of number with small amount of numbers (compare to generate sparse pilot pattern) from this pool. It's easy to see that the possibility of having the same number in two randomly selected sets of number is very low.
   Therefore, sparse pilot generation method is a good method for the following reasons:
      It could perform channel estimation with fewer pilot signals required compared to 5G-NR.
      It could save the signaling for communicating the pilot resource mapping and allocation information compared to 5G-NR.

Although sparse pilot generation method have many advantages comparing with traditional pilot generation method such as 5G-NR method, there is still a remaining issue with applying this method in the system: pilot collision may happen with very small possibility. In this application, we will discuss the methods and solutions to handle pilot collision problem.
Collision handling in DL

For downlink transmission, when gNB needs to send pilot signals to different UE, the pilot collision may happen.

gNB could have ability to calculate and detect pilot collision happened in downlink.

gNB could need a mechanism to calculate and detect impending pilot collisions for all the scheduled UEs. gNB could record related information of all the detected pilot collisions.
gNB could generate UE specific pilot pattern for every UE scheduled for transmission on a certain radio resource in downlink. Then gNB could calculate and detect all the pilot collisions happened based on these UE's specific pilot patterns on this radio resource. If needed, gNB could record related information of pilot collision which may contain but not limited to: location of pilot collision (ex. on which subcarrier, or on which subcarrier over which OFDM symbol), collision UE identifications (ex. UE IDs for all UEs allocated to transmit pilot on this location of pilot collision), pilot symbol for each collision UE, transmission energy for pilot symbol for each collision UE, antenna port assigned for pilot transmission for each collision UE and other pilot or collision related information.
Pilot symbol is the value of pilot signal transmitted. Pilot symbol is usually taken from a symbol in modulation constellation.
In one example, gNB could generate all the scheduled UE pilot patterns on allocated radio resource, then gNB could map the UE specific pilot pattern of all the scheduled UEs on the same allocated resource scheme to identify all the pilot collisions.
In another example, the gNB could generate pilot patterns of all the scheduled UEs on allocated resource. Then gNB could calculate and identify locations of pilot collision by comparing pilot patterns of all the scheduled UEs.
   2. gNB could Try to Avid or Mitigate Pilot Collision Problem.

In some condition, there may exist many UEs waiting to be scheduled at gNB at any time. In 5G NR or other traditional system structure, the scheduler (ex. resource allocation, RB allocation, TTI allocation and etc.) is performed by considering many factors such as buffer status report, QoS requirement, scheduling request and etc. The scheduling problem is a process of balancing various factors, and there are always many different possible scheduling decisions (scheduler options). Different scheduler option will schedule different UEs and have different resource allocation scheme. Because the scheduler option is not unique, we may request gNB to select a scheduler option to schedule such UEs which could result in no pilot collision or less locations of pilot collision. This will avoid or mitigate pilot collision problem.

In one example, we could add a new factor which represents “less pilot collision possibility” to scheduler in order to schedule UEs which could result in no or less locations of pilot collision. After considering all factors of scheduler including buffer status report, QoS requirement, scheduling request, pilot collision and etc. comprehensively, gNB makes scheduling decision.

In another example, we could request scheduler to generate a certain number of scheduler options based on general scheduling factors such as buffer status report, QoS requirement, scheduling request and etc. without considering factors related to “less pilot collision possibility” for a certain radio resource. Since gNB could have the ability to calculate and detect the pilot collisions for all the scheduled UEs for the scheduler option, gNB could evaluate pilot collision happened on each scheduler option. Based on these evaluations we could decide which scheduler option to select as final scheduler option taken on a certain radio resource. One example of evaluation criteria could be to select scheduler option with less locations of pilot collision happened. There could be other evaluation criteria regarding different aspect to mitigate the influence of pilot collision in the system.

In some condition, gNB could determine some parameters (ex. random seed) related to pilot pattern generation procedure of UE. This means gNB could influence the generation of pilot pattern of a UE by selecting different parameters. In the case of multiple UEs being scheduled simultaneously, gNB could use carefully designed parameters to ensure that the pilot patterns generated for different UEs will have less locations of pilot collision or even no pilot collision. gNB could define parameters for pilot pattern generation for a single UE. gNB could also define parameters for pilot pattern generation for some UEs. The related parameters will be communicated to UEs in downlink by using broadcast, multicast or unicast signaling. This signaling could contain the information regarding parameters defined by gNB for pilot pattern generation for a UE or for a group of UEs.

3. If Pilot Collision could Happen in Downlink, gNB could Need to Handle Pilot Collision.

If collision is unavoidable, gNB could have many options to handle pilot collision. Firstly, gNB may have the ability to calculate and detect pilot collision. In some condition, gNB could use its ability to calculate and detect pilot collision. Then gNB could evaluate the collision situation. This evaluation may include to acquire all the locations of pilot collision (ex. subcarrier index, RE index, TTI index and etc.), the identification of UEs scheduled to transmit pilot signals on the locations of pilot collision, the antenna port assigned for UEs on the locations of pilot collision, pilot symbol allocated for UEs on the locations of pilot collision, and etc. With the evaluation results, gNB could make the decision on what to do next.

gNB could use the following methods to handle the pilot collision problem. In the following description, if gNB and UE has multiple antenna ports, in receiver side, each antenna port as indicated in pilot pattern will receive pilot signal sending from one transmitter antenna port. When we talking about a receiver (gNB/UE) ignoring a pilot signal, it means all the antenna ports of receiver will not measure this pilot signal. When we talking about a receiver (gNB/UE) measuring a pilot signal, it means the antenna ports as indicated in receiving pilot pattern will measure this transmitted pilot signal.

### Method A

gNB could send a common pilot signal on pilot collision location. The value of common pilot signal and antenna port assigned to transmit common pilot signal could be calculated based on some configured parameters following the method defined in specification. No special operation of channel estimation procedure could be required from UE side.

In system, gNB could define pilot symbol and antenna port assigned to transmit pilot signal based on some configured parameters. In one example, the configured parameters could be the location of pilot signal. The location of pilot signal could be referred by index in frequency and/or time direction. For example, the pilot symbol and antenna port assigned to transmit that pilot symbol could be determined based on subcarrier index in frequency direction and/or OFDM symbol index in time direction. This method of determining pilot symbol and antenna port assigned to transmit pilot could be applied to all the pilot signals transmitted from gNB. It means when multiple UEs scheduled to transmit pilot signal on a certain location defined by subcarrier index and/or OFDM symbol index, the pilot symbol and antenna port assigned to transmit pilot could be the same for different UE. Therefore, we could transmit the pilot signal with pilot symbol and antenna port assigned to transmit pilot calculated from some configured parameters as defined in specification when pilot collision happens.

When the system transmit pilot signals by using this method, the pilot symbol is pre-defined on each location, and the antenna port assigned to transmit pilot is also pre-defined on each location. Therefore, when the system needs to send pilot signals, it only needs to get the information of pilot location in frequency and/or time direction of each scheduled UE.

On UE side, UE could need to know the methods on how the system defines the pilot symbol and antenna port assigned to transmit pilot. These methods could be defined in the specification. Since from UE side, the pilot signals sent to him could be like what UE expected as defined in pilot pattern, UE could perform normal pilot signal processing and channel estimation calculation as if pilot collision doesn't occurred.

### Method B

gNB could inform related UEs about the locations of pilot collision explicitly. gNB could calculate and detect the impending locations of pilot collision, and then gNB could make decision on where (on which locations of pilot collision) to send common pilot signals. Then gNB could inform related UEs about information of common pilot signals such as the location of common pilot signal, value of the common pilot signal (common pilot symbol) and antenna port assigned to transmit common pilot signal by signaling in downlink. UE could receive and interpret this signaling, and then perform pilot signal processing and channel estimation as defined in his own system.

gNB could define a pilot symbol and antenna port assigned to transmit this pilot symbol on a location of pilot collision. Then gNB needs to transmit these gNB defined information to the related UEs. gNB could broadcast, multicast or unicast these information by using signaling in downlink. This signaling could include the information about the pilot collision and the pilot signal transmitted on the locations of pilot collision, which may include but not limited to number of locations of pilot collision, location information of pilot collision (ex. RE index and/or TTI index), pilot symbol on each location of pilot collision, antenna port index assigned to transmit pilot symbol on each location of pilot collision, transmission power used to send pilot on each location of pilot collision and etc.

In some condition, the pilot symbol and antenna port index assigned to transmit this pilot symbol could be the pilot symbol and antenna port index of one UE selected from multiple collision UEs on the location of pilot collision.

In some condition, the pilot symbol and antenna port index assigned to transmit this pilot symbol could be picked up from a set of predefined values known both to gNB and UEs. The predefined values may include but not limited to pilot symbol, antenna port index assigned to transmit pilot symbol, transmission power and etc. Instead of enumerate values, the gNB could only need to indicate the index of selection from a set of predefined values in downlink signaling.

On UE side, UE needs to receive and interpret this signaling, then UE could take operation as defined in his own system. In some condition, UE could ignore the pilot signals sending on the locations of pilot collision and perform channel estimation without pilot signals transmitted on these locations of pilot collision. In some condition, UE could measure the pilot signals sending on the locations of pilot collision and perform channel estimation with considering the pilot signals transmitted on the collision locations.

Method C gNB could inform related UEs about the locations of pilot collision explicitly. gNB could calculate and detect the impending locations of pilot collision, and gNB could make decision on where (on which locations of pilot collision) to not send any signal. Then gNB could inform related UEs about the null signal transmitted on the locations of pilot collision by signaling. UE could receive and interpret this signaling, and then perform pilot signal processing and channel estimation as defined in his own system.

gNB could send nothing on a location of pilot collision. Then gNB could transmit the information about the location of pilot collision where no signal transmitted to the related UEs. gNB could broadcast, multicast or unicast this information by using signaling in downlink. This signaling could include the information regarding the location of pilot collision where no signal will be transmitted, which may include but not limited to number of locations of pilot collision, location information of pilot collision (ex. RE index and/or OFDM symbol index), indication of no signal transmitted and etc. When this signaling is transmitted in unicast mode, which only gives to one specific UE, the information regarding the locations of pilot collision could be the pilot collisions related to this specific UE. When this signaling is transmitted in multicast or broadcast mode, which targets a group of UEs, the information of locations of pilot collision could be all the pilot collisions involved in this group of UEs, and the information of locations of pilot collision could be listed UE by UE.

On UE side, UE needs to receive and interpret this signaling, then UE could take operation as defined in his own system. From this signaling, UE will know which pilot location in his own pilot pattern is the location of pilot collision happened and where there is no pilot signal transmitted. In some condition, UE could remove the location of pilot collision from his own pilot pattern (this means to stop measuring the pilot signal on all the related antenna ports receiving on the location of pilot collision), then perform channel estimation without considering pilot signal on that location.

### Method D

gNB could calculate and detect the impending locations of pilot collision, and gNB could make decision on where (on which locations of pilot collision) to not send any signal. Then gNB could do nothing special including inform UEs the locations of pilot collision by signaling. Once UE receives pilot signal, UE could perform pilot signal processing and channel estimation as defined in his own system.

On the UE side, UE could define some mechanism to operate on the received and measured pilot signals.

UE will detect and measure the signal power received on all pilot locations. If UE has multiple antenna ports, the antenna ports as defined in UE's pilot pattern will be used to receive pilot signal and each antenna port will generate a measured pilot signal power value. Therefore, multiple antenna ports will generate multiple measured pilot signal power values from the same transmitted pilot signal. We could apply some algorithm on these multiple measured pilot signal power values generated from one transmitted pilot signal and calculate an indication value (we use “indication signal power” in the following description) to represent the received signal level measured on a transmitted pilot signal. In one example, we could average on these multiple measured pilot signal power values to get this indication signal power.

In one example, UE could define two threshold, the high threshold and low threshold. If the indication signal power is higher than the high threshold or lower than low threshold, UE will consider this transmitted pilot signal has been interfered with or has a problem. UE could discard the pilot signal measured on all the antenna ports on this location and perform channel estimation without considering pilot signal transmitted on this location. In another example, UE could define one threshold, the low threshold. Each time, UE will detect and measure the indication signal power received on all pilot locations. If the indication signal power is lower than low threshold, UE will take this pilot location has no pilot signal transmitted. UE could discard the pilot signal measured on all the antenna port on this location and perform channel estimation without considering pilot signal transmitted on this location.

By using such method in UE side, UE could has the ability to identify the locations where gNB has not transmit pilot signal when pilot collision happens.

Method B, Method C and Method D could be taken to operate on one location of pilot collision. Therefore, different methods (method B, C or D) could be taken for different location of pilot collision for a certain radio resource.

In some condition, different UE could adopt different method of method B, method C and method D. In one example, for a certain radio resources, the pilot collisions related to one UE could be treated by method B. At the same time, pilot collisions related to another UE could be treated by method D.

### Collision Handling in UL

For uplink transmission, when pilot signals are sent from different UE to gNB, the pilot collision may happened.

In some condition, the pilot pattern for UE in uplink transmission is scheduled and assigned by gNB. Therefore, gNB could have the ability to calculate and detect impending pilot collision in uplink.

In some condition, gNB could need a mechanism to detect pilot collisions for all the scheduled UEs. Once detected, gNB could record related information of all the detected pilot collisions.
gNB could generate UE specific pilot pattern for every UE scheduled for transmission on a certain radio resource in uplink. Then gNB could calculate and detect all the impending pilot collisions based on these UE specific pilot patterns on this radio resource. If needed, gNB could record related information of pilot collision which may contain but not limited to: location of pilot collision (ex. on which subcarrier over which OFDM symbol), collision UE identifications (ex. UE IDs for all UEs allocated to transmit pilot on this location of pilot collision), pilot symbol for each collision UE, transmission energy for pilot symbol for each collision UE, antenna port assigned for pilot transmission for each collision UE and other pilot or collision related information.
In one example, the gNB could generate all the scheduled UE pilot patterns on allocated resource in uplink transmission, then gNB could map the UE specific pilot pattern of all the scheduled UEs on the same allocated resource scheme to identify all the pilot collisions.
In another example, the gNB could generate all the scheduled UE pilot pattern on allocated resource in uplink transmission. Then gNB could calculate and identify location of pilot collision by comparing pilot patterns of all the scheduled UEs.
   1. gNB could Try to Avid or Mitigate Pilot Collision Problem.

In some condition, there may exist many UEs waiting to be scheduled at gNB at any time for uplink transmission. In 5G NR or other traditional system structure, the scheduler (ex. resource allocation, RB allocation, TTI allocation and etc.) is performed by considering many factors such as buffer status report, QoS requirement, scheduling request and etc. The scheduling problem is a process of balancing various factors, and there are always many different possible scheduling decisions (scheduler options). Different scheduler option will schedule different UEs and have different resource allocation scheme. Because the scheduler option is not unique, we may request gNB to select a scheduler option to schedule such UEs which could result in no pilot collision or less locations of pilot collision. This will avoid or mitigate pilot collision problem.

In one example, we could add a new factor which represents “less pilot collision possibility” to scheduler in order to schedule UEs which could result in no or less locations of pilot collision in uplink transmission. After considering all factors of scheduler including buffer status report, QoS requirement, scheduling request, pilot collision and etc. comprehensively, gNB makes scheduling decision.

In another example, we could request scheduler to generate a certain number of scheduler options based on general scheduling factors such as buffer status report, QoS requirement, scheduling request and etc. without considering factors related to “less pilot collision possibility” for a certain radio resource in uplink transmission. Since gNB could have the ability to calculate and detect the pilot collisions for all the scheduled UEs for the scheduler option, gNB could evaluate the impending pilot collision on each scheduler option. Based on these evaluations we could decide which scheduler option to select as final scheduler option taken on a certain radio resource. One example of evaluation criteria could be to select scheduler option with less locations of pilot collision. There could be other evaluation criteria regarding different aspect to mitigate the influence of pilot collision in the system.

In some condition, gNB could determine some parameters (ex. random seed) related to pilot pattern generation procedure of UE. This means gNB could influence the generation of pilot pattern of a UE by selecting different parameters. In the case of multiple UEs being scheduled simultaneously, gNB could use carefully designed parameters to ensure that the pilot patterns generated for different UEs will have less locations of pilot collision or even no pilot collision. gNB could define parameters for pilot pattern generation for a single UE. gNB could also define parameters for pilot pattern generation for some UEs. The related parameters will be communicated to UEs in downlink by using broadcast, multicast or unicast signaling. This signaling could contain the information regarding parameters defined by gNB for pilot pattern generation for a UE or for a group of UEs.

If pilot collision could happen in uplink, gNB could need to handle pilot collision.

If collision is unavoidable, gNB could have many options to handle pilot collision. Firstly, gNB may have the ability to calculate and detect pilot collision. In some condition, gNB could use its ability to calculate and detect pilot collision. Then gNB could evaluate the collision situation. This evaluation may include to acquire all the locations of pilot collision (ex. subcarrier index, RE index, TTI index and etc.), the identification of UEs scheduled to transmit pilot signals on the locations of pilot collision, the antenna port assigned for UEs on the locations of pilot collision, pilot symbol allocated for UEs on the locations of pilot collision, and etc. With the evaluation results, gNB could make the decision on what to do next.

gNB could use the following methods to handle the pilot collision problem. In the following description, if gNB and UE has multiple antenna ports, each antenna port as indicated in receiving pilot pattern will receive pilot signal sending from one transmitter antenna. When we talking about gNB ignoring a pilot signal, it means all the antenna ports of gNB will not measure on this transmitted pilot signal. When we talking about gNB measuring a pilot signal, it means the antenna ports of gNB as indicated in receiving pilot pattern will measure this transmitted pilot signal.

### Method E

By using this method, gNB could calculate and detect the impending locations of pilot collision and inform related UEs the locations of pilot collision where gNB wants UE to avoid sending pilot signal by downlink signaling. UE could receive and interpret this signaling, and act as gNB expected to avoid sending pilot signal on the indicated location of pilot collision.

In some condition, gNB could request all the collision UEs on location of pilot collision to not transmit pilot signal on location of pilot collision. The signaling could include the information regarding the locations of pilot collision, which may include but not limited to number of locations of pilot collision, location information of pilot collision (ex. RE index and/or OFDM symbol index), expected handling method for UE (ex. no signal transmitted on location of pilot collision) and etc. When this signaling is transmitted in unicast mode, which only gives to one specific UE, the information regarding the locations of pilot collision could be the pilot collisions related to this specific UE. When this signaling is transmitted in multicast or broadcast mode, which targets a group of UEs, the information of locations of pilot collision could be all the impending pilot collisions happened on this group of UEs, or the information of location of pilot collision could be listed UE by UE.

In some condition, gNB could select one UE to remain transmitting pilot signal on the location of pilot collision and request all the other related UEs to not transmit pilot signal on location of pilot collision. gNB doesn't need to send special signaling to the transmitting UE, but need to send signaling to inform all the other related UEs who has been requested to stop transmitting pilot signal on the location of pilot collision. The signaling sending to all the other related UEs could include the information regarding the location of pilot collision, which may include but not limited to number of locations of pilot collision, location information of pilot collision (ex. RE index and/or OFDM symbol index), expected handling method for UE (ex. no signal transmitted on location of pilot collision) and etc. When this signaling is transmitted in unicast mode, which only gives to one specific UE, the information regarding the locations of pilot collision could be the pilot collisions related to this specific UE. When this signaling is transmitted in multicast or broadcast mode, which targets a group of UEs, the information of locations of pilot collision could be all the impending pilot collisions happened on this group of UEs, or the information of location of pilot collision could be listed UE by UE.

UE could receive and interpret this signaling, and stop to send pilot signal on the locations of pilot collision as indicated by gNB.

On gNB side, gNB could has the knowledge of what pilot pattern each UE used in transmitting pilot signal. Once gNB sends downlink signaling to request some UEs to stop transmitting pilot signals on some locations of pilot collision, gNB could updated its receiving pilot pattern for related UEs accordingly to remove locations of pilot collision where no pilot signal will be transmitted from related UEs. gNB could perform channel estimation on a UE by UE base. For a UE who has been requested to stop transmitting pilot signals on locations of pilot collision, gNB could perform channel estimation of that UE with the updated receiving pilot pattern for that UE, which will not consider the pilot signal on locations of pilot collision.

### Method F

By using this method, gNB could choose to do nothing related to locations of pilot collision in downlink signaling. In some condition, gNB could not calculate and detect impending locations of pilot collision. In some condition, gNB could have calculate and detect locations of pilot collision but make decision to not inform related UEs.

UEs could send pilot signals as defined in UE's pilot pattern.

On the gNB side, when gNB receives pilot signal, gNB could perform pilot signal processing and channel estimation as defined in the system.

In some condition, gNB could not calculate and detect locations of pilot collision and gNB has no pre-knowledge of locations of pilot collision. gNB could define some mechanism to operate on the received and measured pilot signals.

In general, gNB will detect and measure the signal power received on all pilot locations. If gNB has multiple antenna ports, the antenna ports as defined in receiving pilot pattern will be used to receive pilot signal and each antenna port will generate a measured pilot signal power value. Therefore, multiple antenna ports will generate multiple measured pilot signal power values from the same transmitted pilot signal. We could apply some algorithm on these multiple measured pilot signal power values generated from one transmitted pilot signal and calculate an indication value (we use “indication signal power” in the following description) to represent the received signal level measured on a transmitted pilot signal. In one example, we could average on these multiple measured pilot signal power values to get this indication signal power.

In one example, gNB could define two threshold, the high threshold and low threshold. If the indication signal power on a location is higher than the high threshold or lower than low threshold, gNB will consider that the transmitted pilot signal on this location has been interfered with or has a problem. gNB could discard the pilot signal measured on all the antenna ports on this location and perform channel estimation without considering pilot signal transmitted on this location. In another example, gNB could define one threshold, the low threshold. Each time, gNB will detect and measure the indication signal power received on all pilot locations. If the indication signal power is lower than low threshold, gNB will take this pilot location has no pilot signal transmitted. gNB could discard the pilot signal measured on all the antenna port on this location and perform channel estimation without considering pilot signal transmitted on this location.

In some condition, gNB could calculate and detect locations of pilot collision and gNB has pre-knowledge of locations of pilot collision. gNB knows where to expect the multiple pilot signals received on the same pilot location. gNB could discard the pilot signal measured on all the antenna ports on this location and perform channel estimation without considering pilot signal transmitted on this location.

Method E and Method F could be taken to operate on one location of pilot collision. Therefore, different methods (method E or F) could be taken for different location of pilot collision for a certain radio resource.

In some condition, gNB could apply different method (method E or F) on different UE. In one example, for a certain radio resources, the pilot collisions related to one UE could be treated by method E. gNB will inform the UE of pilot collision location by using signaling in downlink and request UE to avoid sending pilot signal on the locations of pilot collision. At the same time, pilot collisions related to another UE could be treated by method F. gNB will not inform the UE of location of pilot collision. gNB let the UE to transmit pilot signals on locations of pilot collision. gNB will discard the pilot signal received on location of pilot collision and perform channel estimation of that UE without considering pilot signals on locations of pilot collisions.

### EXAMPLES

### 1. Example 1

In example 1, we are going to illustrate a design of solving pilot collision problem in downlink by using method A. In this example, a certain radio resource is 24 subcarriers with subcarrier index 1 to 24 over 1 OFDM symbol with time symbol index n. After scheduling, gNB plans to transmit pilot signals on subcarrier index 1, 4, 12 and 21 of OFDM symbol n to UE1. gNB also plans to transmit pilot signals on subcarrier index 3, 7, 12 and 22 of OFDM symbol n to UE2. gNB could use its ability to calculate and detect the impending pilot collision. Since both pilot location to UE1 and pilot location to UE2 are planned to transmit a pilot signal on subcarrier index 12, pilot collision is going to happen on subcarrier 12 on OFDM symbol index n.

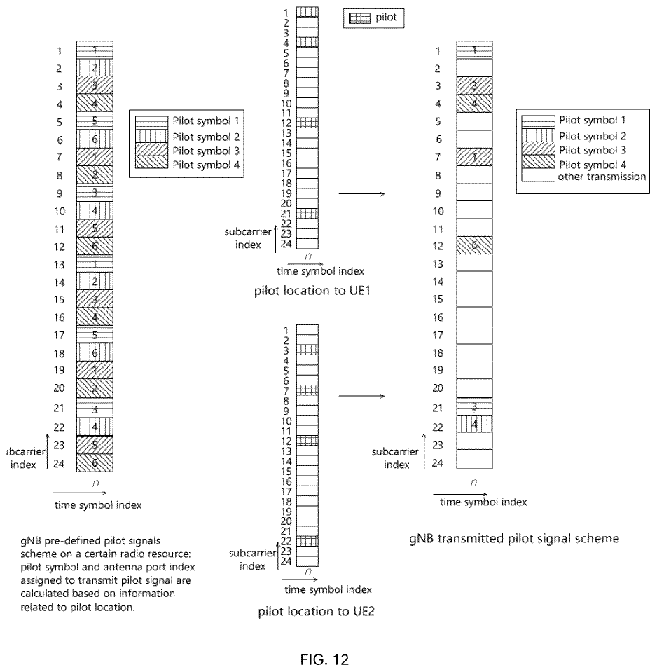

In method A, the pilot symbol and antenna port assigned to transmit pilot signal on each pilot location is defined based on some configured parameters. In this example, we assume the pilot symbol and antenna port assigned to transmit pilot is calculated based on subcarrier index. FIG. 12 is a schematic diagram of illustration of method A for solving pilot collision in downlink. As shown in FIG. 12 left part, different color represents different pilot symbol for pilot signal on a location. We assume 4 pilot symbols in the system. The number on each subcarrier is the antenna port index assigned to transmit pilot signal. For example, if there is a pilot signal planning to transmit on subcarrier index 1, we are going to use antenna port index 1 to transmit pilot symbol 1 on this location. If there is a pilot signal planning to transmit on subcarrier index 18, we are going to use antenna port index 6 to transmit pilot symbol 2 on this location.

In this example, on each location of this radio resource, there is pre-defined pilot symbol and antenna port index assigned to transmit pilot calculated based on subcarrier index. For the location of pilot collision (subcarrier index 12), a common pilot signal (pilot symbol 4) and antenna port index assigned to transmit common pilot signal (antenna port index 6) will be used. After considering the other pilots to UE1 and UE2, the final pilot signal scheme is shown in the right part of FIG. 12. On the UE side, both UE1 and UE2 will receive pilot signals as expected in its pilot pattern.

### 2. Example 2

In example 2, we are going to illustrate a design of solving pilot collision problem in downlink by using method B, C and D. We mentioned in previous description that method B, C and D could be used to solve impending pilot collision happened on a location of pilot collision and could be applied on a UE by UE base, therefore, they could be mixed to use for a certain radio resource.

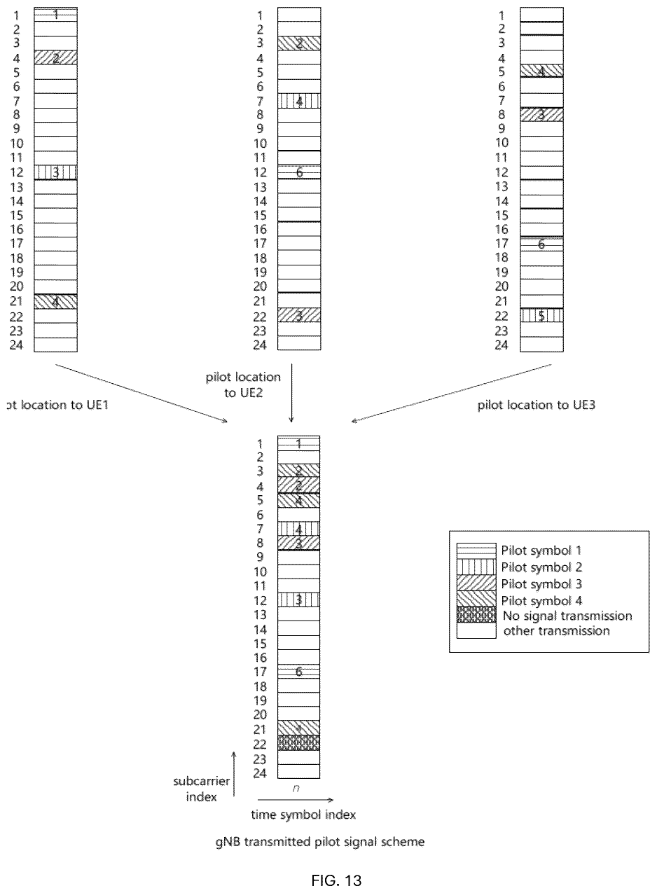

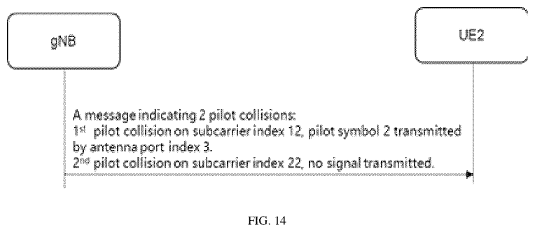

In this example, a certain radio resource is 24 subcarriers with subcarrier index 1 to 24 over 1 OFDM symbol with time symbol index n. After scheduling, gNB plans to transmit pilot signals on subcarrier index 1, 4, 12 and 21 of OFDM symbol n to UE1. gNB plans to transmit pilot signal on subcarrier index 3, 7, 12 and 22 of OFDM symbol n to UE2. gNB also plans to transmit pilot signal on subcarrier index 5, 8, 17 and 22 of OFDM symbol n to UE3. Pilot location to UE1, UE2 and UE3 is shown in the upper part of FIG. 13. FIG. 13 is a schematic diagram of method B, C and D for solving pilot collision in downlink. Different color represents different pilot symbol used in the pilot transmission. The number on subcarrier box is antenna port index assigned to transmit pilot signal.

gNB could use its ability to calculate and detect the impending pilot collision. Since both pilot location to UE1 and pilot location to UE2 are planned to transmit a pilot signal on subcarrier index 12, pilot collision is going to happen on subcarrier 12 on OFDM symbol index n. Since both pilot location to UE2 and pilot location to UE3 are planned to transmit a pilot signal on subcarrier index 22, pilot collision is going to happen on subcarrier 22 on OFDM symbol index n.

After analyzing condition of pilot collision, gNB plans to use pilot symbol (pilot symbol 2) and antenna port index assigned to transmit pilot signal (antenna port index 3) on subcarrier index 12 of UE1 to solve impending pilot collision happened on subcarrier index 12. And gNB will inform UE2 of location of pilot collision (subcarrier index 12), pilot symbol (pilot symbol 2) and antenna port index assigned to transmit pilot signal (antenna port index 3) by using downlink signaling. This operation is defined in method B.

gNB also plans to avoid transmitting any signal on subcarrier index 22 to solve impending pilot collision happened on subcarrier index 22. And gNB will inform UE2 of location of pilot collision (subcarrier index 22) and no signal transmitted on that location by using downlink signaling as defined in method C. Regarding UE3, gNB will not send any information to UE3 and let UE3 to operate channel estimation as defined in its own system as in method D.

In this example, gNB needs to inform UE2 about information on two locations of pilot collision. A signaling example is shown in FIG. 14. FIG. 14 is a schematic diagram of gNB to UE2 signaling example. This information could be unicast information transmitting to UE2. This information could be multicast or broadcast in downlink with UE2 as a receiver. gNB could combine this information with other signaling. And information on two locations of pilot collision could be separated in two different messages in downlink signaling.

After resolving the impending pilot collision on subcarrier 12 and subcarrier 22, and consider the other pilot signals in pilot locations to UE1, UE2 and UE3, the final pilot signal scheme is shown in the lower part of FIG. 13. On the UE side, UE1 will receive all the 4 pilot signals as expected in its pilot pattern. UE2 will receive 2 pilot signals transmitted on subcarrier index 3 and 7 normally as expected, and will receive 1 pilot signal transmitted on subcarrier index 12 with pilot symbol 2 transmitted from antenna port index 3. UE2 could perform channel estimation with considering these 3 transmitted pilot signals or only considering pilot signals transmitted on subcarrier index 3 and 7. UE3 will expect to receive pilot signals on all subcarriers as defined in pilot pattern. UE3 could measure indication signal power on all the locations. Then UE3 could apply the predefined thresholds to determine which pilot signals to consider in doing channel estimation.

### 3. Example 3

In example 3, we are going to illustrate a design of solving impending pilot collision in uplink by using method E and F. We mentioned in previous description that method E and F could be used to solve impending pilot collision happened on a location of pilot collision and could be applied on a UE by UE base, therefore, method E and F could be mixed to use for a certain radio resource.

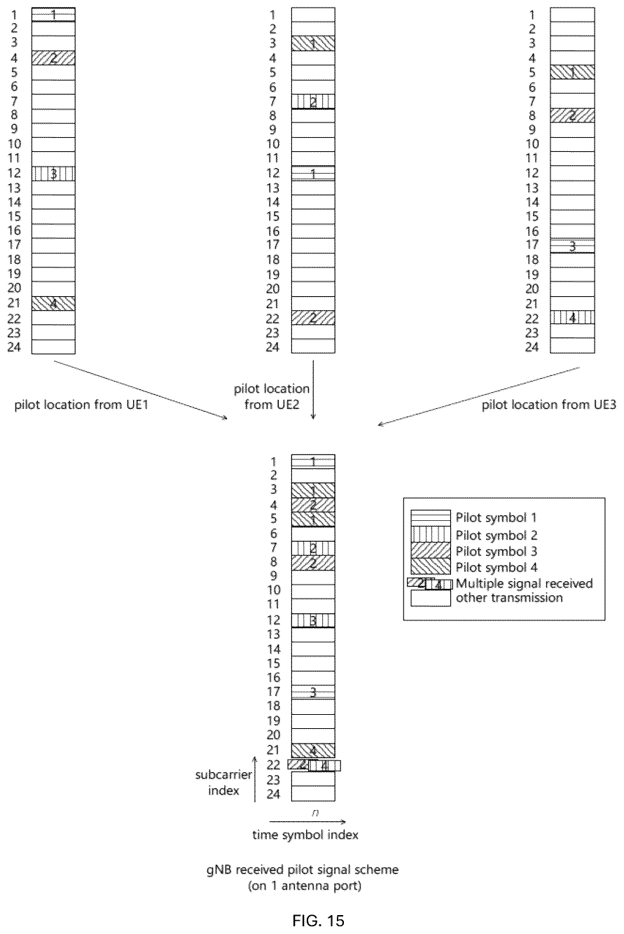

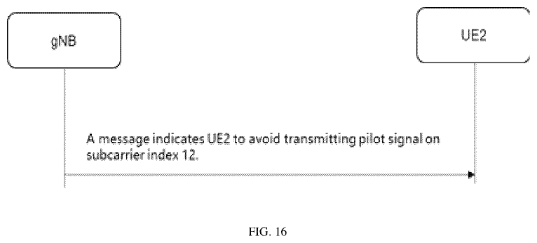

In this example, a certain radio resource is 24 subcarriers with subcarrier index 1 to 24 over 1 OFDM symbol with time symbol index n. After scheduling, gNB plans to schedule UE1, UE2 and UE3 to transmit pilot on this radio resource. gNB also knows the pilot signals from UE1 is expected on subcarrier index 1, 4, 12 and 21 of OFDM symbol n. Pilot signals from UE2 is expected on subcarrier index 3, 7, 12 and 22 of OFDM symbol n. Pilot signals from UE3 is expected on subcarrier index 5, 8, 17 and 22 of OFDM symbol n. Pilot location from UE1, UE2 and UE3 is shown in the upper part of FIG. 15. FIG. 15 is a schematic diagram of method E and F for solving pilot collision in uplink. Different color represents different pilot symbol used in the pilot transmission. The number on subcarrier box is antenna port index assigned to transmit pilot signal.

gNB could use its ability to calculate and detect all the impending pilot collision. Since both pilot location from UE1 and pilot location from UE2 are planned to transmit a pilot signal on subcarrier index 12, pilot collision is going to happen on subcarrier 12 on OFDM symbol index n. Since both pilot location from UE2 and pilot location from UE3 are planned to transmit a pilot signal on subcarrier index 22, pilot collision is going to happen on subcarrier 22 on OFDM symbol index n.

After analyzing condition of pilot collision, gNB plans to allow UE1 to transmit pilot signal on subcarrier 12 and stop UE2 to transmit its pilot signal on the same subcarrier. And gNB will inform UE2 of location of pilot collision (subcarrier index 12) and operation such as not to transmit pilot signal by using downlink signaling. This operation is defined in method E.

gNB also detects pilot collision happened on subcarrier index 22. gNB plans to let UE2 and UE3 transmit their pilot signal as normal on this location. gNB will not send any information to UE2 and UE3 regarding pilot collision on subcarrier index 22 as defined in method F.

In this example, gNB needs to inform UE2 about information on one location of pilot collision. A signaling example is shown in FIG. 16. FIG. 16 is a schematic diagram of gNB to UE2 signaling example. This information could be unicast information transmitting to UE2. This information could be multicast or broadcast in downlink with UE2 as a receiver. gNB could combine this information with other signaling.

After resolving the impending pilot collision on subcarrier 12 and subcarrier 22, consider the other pilot signals in pilot locations to UE1, UE2 and UE3, the final pilot signal scheme is shown in the lower part of FIG. 15. gNB expects to receive and measure four pilot signals from UE1 and will do channel estimation with considering these four pilot signals. gNB expects to receive only two pilot signals normally from UE2 which are pilot signals transmitted on subcarrier index 3 and 7. gNB will do channel estimation for UE2 channel with considering these two pilot signals. gNB expects to receive three pilot signals normally from UE3 which are pilot signals transmitted on subcarrier index 5, 8 and 17. gNB will do channel estimation for UE3 channel with considering these three pilot signals. In some condition, gNB may separate overlapped signals on subcarrier index 22 with advanced signal processing algorithm when transmitted signal symbol is different from different UE. Then gNB could perform channel estimation for UE2 channel with pilot signal received on subcarrier index 3, 7 and 22. gNB could perform channel estimation for UE3 channel with all pilot signal transmitted.

This application is about how to solve the problem when multiple UEs allocate to transmit pilot signals on the same location in both down and uplink. Propose solutions to solve the problem of pilot collision happened when sparse pilot pattern is used in MIMO system.

The methods herein are performed by a device or an apparatus, e.g. by a processor of the device or apparatus executing instructions stored in a memory. The instructions, when executed, cause the device or apparatus to perform the methods.

The various options and embodiments described herein may be combined in different permutations. Also, although the application has been described with reference to specific features and embodiments thereof, various modifications and combinations can be made thereto without departing from the application. The description and drawings above are, accordingly, to be regarded simply as an illustration of some embodiments of the application, and are contemplated to cover any and all modifications, variations, combinations or equivalents.

What is claimed is:

1. A method, comprising:
transmitting first information indicating information of a common pilot signal, wherein the common pilot signal is being transmitted on a first resource unit, and pilot signal collision of different communication devices happens at least on the first resource unit; and
transmitting the common pilot signal on the first resource unit.

2. The method according to claim 1, wherein the information of the common pilot signal comprises one or more of: location information of the common pilot signal, a value of the common pilot signal, an antenna port index assigned to the common pilot signal, or a transmission power of the common pilot signal.

3. The method according to claim 1, wherein the different communication devices comprise a first communication device; and
wherein the information of the common pilot signal is determined based on information of a first pilot signal assigned to the first communication device.

4. The method according to claim 3, wherein the information of the common pilot signal is the same as the information of the first pilot signal.

5. The method according to claim 3, wherein transmitting the first information comprises:
transmitting the first information to one or more communication devices other than the first communication device among the different communication devices.

6. A method, comprising:
receiving first information indicating information of a common pilot signal, wherein the common pilot signal is being transmitted on a first resource unit, and wherein pilot signal collision of different communication devices happens at least on the first resource unit; and
receiving the common pilot signal on the first resource unit.

7. The method according to claim 6, wherein the information of the common pilot signal comprises one or more of: location information of the common pilot signal, a value of the common pilot signal, an antenna port index assigned to the common pilot signal, or a transmission power of the common pilot signal.

8. The method according to claim 6, wherein the different communication devices comprise a first communication device; and
wherein the information of the common pilot signal is determined based on information of a first pilot signal assigned to the first communication device.

9. The method according to claim 8, wherein the information of the common pilot signal is the same as the information of the first pilot signal.

10. The method according to claim 6, wherein the information of the common pilot signal is determined based on the first resource unit and a relationship, and wherein the relationship indicates information of pilot signal assigned to the first resource unit.

11. An apparatus, comprising:
at least one processor coupled with at least one memory storing one or more instructions that are capable of being run on the at least one processor, wherein when the one or more instructions are run, the apparatus is enabled to:
transmit first information indicating information of a common pilot signal, wherein the common pilot signal is being transmitted on a first resource unit, and pilot signal collision of different communication devices happens at least on the first resource unit; and
transmit the common pilot signal on the first resource unit.

12. The apparatus according to claim 11, wherein the information of the common pilot signal comprises one or more of: location information of the common pilot signal, a value of the common pilot signal, an antenna port index assigned to the common pilot signal, or a transmission power of the common pilot signal.

13. The apparatus according to claim 11, wherein the different communication devices comprise a first communication device; and
wherein the information of the common pilot signal is determined based on information of a first pilot signal assigned to the first communication device.

14. The apparatus according to claim 13, wherein the information of the common pilot signal is the same as the information of the first pilot signal.

15. The apparatus according to claim 13, wherein transmitting the first information comprises:
transmitting the first information to one or more communication devices other than the first communication device among the different communication devices.

16. An apparatus, comprising:
at least one processor coupled with at least one memory storing one or more instructions that are capable of being run on the at least one processor, wherein when the one or more instructions are run, the apparatus is enabled to:
receive first information indicating information of a common pilot signal, wherein the common pilot signal is being transmitted on a first resource unit, wherein pilot signal collision of different communication devices happens at least on the first resource unit; and
receive the common pilot signal on the first resource unit.

17. The apparatus according to claim 16, wherein the information of the common pilot signal comprises one or more of: location information of the common pilot signal, a value of the common pilot signal, an antenna port index assigned to the common pilot signal, or a transmission power of the common pilot signal.

18. The apparatus according to claim 16, wherein the different communication devices comprise a first communication device; and
wherein the information of the common pilot signal is determined based on information of a first pilot signal assigned to the first communication device.

19. The apparatus according to claim 18, wherein the information of the common pilot signal is the same as the information of the first pilot signal.

20. The apparatus according to claim 16, wherein the information of common pilot signal is determined based on the first resource unit and a relationship, and wherein the relationship indicates information of pilot signal assigned to the first resource unit.
